(19) United States
(12) Patent Application Publication
(10) Pub. No.: US 2025/0271653 A1
(43) Pub. Date: Aug. 28, 2025

(54) LIGHTFIELD IMAGING AND REAL-TIME PLENOPTIC DISPLAY SYSTEM AND METHOD OF OPERATING SAME

(71) Applicant: Raytrx, LLC, Tulsa, OK (US)

(72) Inventors: Jordan Boss, Tulsa, OK (US); Michael Hayes Freeman, J.D., Tulsa, OK (US); Mitchael C. Freeman, Tulsa, OK (US); Steven Von der Porten, Tulsa, OK (US); Behnam Rafiee, Tulsa, OK (US); Montgomery Freeman, Tulsa, OK (US); Kenbe Goertzen, Tulsa, OK (US)

(21) Appl. No.: 19/064,614

(22) Filed: Feb. 26, 2025

Related U.S. Application Data
(60) Provisional application No. 63/557,917, filed on Feb. 26, 2024.
(60) Provisional application No. 63/570,451, filed on Mar. 27, 2024.

(51) Int. Cl. G02B 21/22; G02B 21/00; G02B 21/36; H04N 23/957

(52) U.S. Cl. CPC G02B 21/22; G02B 21/008; G02B 21/367; G02B 21/368; H04N 23/957

(57) ABSTRACT

A lightfield imaging system is described herein. The lightfield imaging system includes a display device for displaying three-dimensional (3D) video images of a volume of interest and a lightfield microscope assembly. The lightfield microscope assembly includes a microscope housing, a Multiple Angle Capture (MAC) sensor array including a plurality of sensors mounted to the microscope housing, an objective lens assembly mounted to the microscope housing and configured to direct light rays from a volume of interest to each of the sensors, and a microscope controller coupled to the display device and the sensors. The microscope controller includes a memory device for storing computer-executable instructions thereon and one or more processors for executing the computer-executable instructions for performing an algorithm for rendering 3D video images of the volume of interest onto the display device.

### CROSS REFERENCE TO RELATED APPLICATIONS

This application claims the benefit of U.S. Provisional application Ser. No. 63/557,917 filed on Feb. 26, 2024 and claims the benefit of U.S. Provisional application Ser. No. 63/570,451 filed on Mar. 27, 2024, the disclosures of which are hereby incorporated by reference in their entirety and for all purposes.

### TECHNICAL FIELD

The present disclosure generally relates to a real-time lightfield 3d video imaging and display system which Ocutrx calls LightField3D™ System. The system is a camera and display system which can be incorporated into a surgery microscope, a hand-held or mounted camera system, or shrunk down to fit into a laparoscopic camera system. In each case the image capture system is presented on a plenoptic monitor in real-time holographic 3D or it can be augmented to a stereoscopic 3D system and displayed on a stereoscopic 3D monitor; or it can be augmented to display on a 2D monitor.

### COPYRIGHT NOTICE

A portion of this disclosure contains material that is subject to copyright protection. The copyright owner has no objection to the facsimile reproduction by anyone of this patent document as it appears in the U.S. Patent and Trademark Office, patent file, or records, but reserves all copyrights whatsoever in the subject matter presented herein.

### BACKGROUND

For a surgery application, the Standard Optical Microscope or SOM has been used for about 100 years perform imaging using the same basic optical paradigm wherein light is magnified by a common main objective and then split into two channels which relay different perspectives of the image to eyepieces. From this configuration the image is observed by the human eye. Over time significant advances have been made such as telescopic systems with long working distance and increased magnification, high-power coaxial illumination and variable magnification using optical zoom. However, the basic stereoscopic implementation has remained the same. In recent years, technologies have emerged that have the potential to disrupt this venerable methodology. There has been much interest in digitally enhanced surgical microscopes which have recently entered the market, however, they continue to operate based on the principle of common main objective with two (2) optical channels where cameras or camera sensors are used in place of the eye pieces.

In contrast, technology has been developed in the area of lightfield image capture and plenoptic display particularly for use in the field of photography. However, this has been limited to pre-produced video or still images. This patent will teach how this dynamic can be improved to be a real-time image capture using multiple cameras or sensors, with a playback on a plenoptic display which provides the viewer with a holographic 3D image that has less than a 60 millisecond lag time from capture to display. The increased richness of the data acquired by lightfield technology enables computational imaging to take advantage of the angular information contained in the recorded light rays which is not available to traditional digital imaging or to traditional stereoscopic image capture. This enables, for example, the reconstruction of the three-dimensional surface of the object being viewed and therefore, the generation of a multitude of perspectives for image analysis and display. This also permits, and this patent teaches, how to correlate all pixels in the streaming video at a analog or digital signal stage before an actual image is created, thus permitting images to be manipulated, augmented, or in whole or part to be replaced from images from a different type of sensor, such as an infrared sensor. This permits the display of a camera sensor image to be displayed with infrared features incorporated into the image in real-time.

Lightfield based optical systems have shown great potential for supporting an expanded range of features and create a 3d image that looks holographic. However, early examples suffered from low resolutions and long processing times which prevented real-time applications and widespread adoption.

The present invention solves one or more of the problems identified above.

### SUMMARY OF INVENTION

In one aspect of the present invention, a lightfield imaging system is provided. The lightfield imaging system includes a plenoptic display device for displaying three-dimensional (3D) holographic video images of a volume of interest and a lightfield microscope assembly. The lightfield assembly in one embodiment for surgery, includes a microscope housing, a Multiple Angle Capture (MAC) sensor array including a plurality of sensors mounted to the microscope housing, an objective lens assembly mounted to the microscope housing and configured to direct all or many light rays from a volume of interest (subject, source, or image) to each of the sensors, and a microscope controller coupled to the plenoptic display device with the resulting video played in holographic 3D. The microscope controller includes a memory device for storing computer-executable instructions thereon and one or more processors for executing the computer-executable instructions for performing an algorithm processing for rendering 3D video images of the volume of interest onto the display device. The algorithm processing can also include executing from controls of the surgeon to include part camera sensors with part near infrared sensors.

The one or more processors performed the algorithm including the steps of operating the MAC sensor array to computationally derive perspective image data of the volume of interest with each sensor in the MAC sensor array sensor or other sensor including, but not limited to sensors such as near infrared sensors, near ultraviolet sensors, and visible light sensors (from 250 nanometers to 1,000 nanometers), time-of-flight sensors, LIDAR sensors, and/or laser sensors. In one embodiment the sensors each capture a different angle perspective which may be an overlapping image perspective of the volume of interest or source, which generates a surface depth map of the volume of interest based on the corrected perspective view image data, generating calibrated volume of interest (CVI) image data for each sensor in the MAC sensor array by mapping corresponding video frame perspective image data onto the generated surface depth map, and generating single source interpolated perspectives views for each sensor in the MAC sensor array based on corresponding CVI image data for each sensor within the MAC sensor array. The one or more processors then perform the algorithm steps of merging the single or multiple source interpolated perspectives views into a desired output perspective view of the volume of interest, generating formatted output data based on image parameters of the display device, and displaying the controller desired output The real-time plenoptic display then gives a holographic video perspective view of the volume of interest on the display device using the formatted output data. Thus, viewers can see a slightly different viewpoint depending on their position vis-à-vis the display. In one embodiment of the invention the display present forty-five (45) different images on the same display using lenslets on the single display monitor.

In another aspect of the present invention, a method of operating a lightfield camera and other sensor imaging system is provided which could be used as a handheld or mounted device or in a smaller configuration as would be needed for use in a laparoscopic device. The lightfield microscope imaging system includes a plenoptic display device for displaying three-dimensional (3D) holographic video images of a volume of interest or source, and a lightfield microscope assembly including a microscope housing, a MAC sensor array including a plurality of sensors mounted to the microscope housing, an objective lens assembly mounted to the microscope housing and configured to direct light rays from a volume of interest to each sensor in the MAC sensor array, and a microscope controller coupled to the display device and the MAC sensor array and including a memory device for storing computer-executable instructions thereon and one or more processors. The method includes the one or more processors executing the computer-executable instructions and performing an algorithm for rendering 3D video images of the volume of interest onto the display device including the steps of operating the MAC sensor array to capture video frame perspective image data of the volume of interest with each sensor in the MAC sensor array capturing a different overlapping image perspective of the volume of interest, generating a surface depth map of the volume of interest based on the corrected perspective view image data, generating calibrated volume of interest (CVI) image data for each sensor in the MAC sensor array by mapping corresponding video frame perspective image data onto the generated surface depth map, and generating single source interpolated perspectives views for each sensor in the MAC sensor array based on corresponding CVI image data for each sensor in the MAC sensor array. The one or more processors then perform the algorithm steps of merging the single source interpolated perspectives views into a desired output perspective view of the volume of interest, generating formatted output data based on image parameters of the display device, and displaying the desired output perspective view of the volume of interest on the display device using the formatted output data. The controller having the option to interpose information from different types of sensors into one outputted video image.

In yet another aspect of the present invention, a non-transitory computer-readable storage media having computer-executable instructions embodied thereon to operate a lightfield imaging system is provided. The lightfield microscope imaging system includes a plenoptic display device for displaying three-dimensional (3D) holographic video images of a volume of interest and a lightfield sensor assembly including, including, for surgeries, a microscope or laparoscope housing, a multiple source perspective lightfield sensor arrays including a MAC sensor array with a plurality of sensors mounted to the microscope housing, an objective lens assembly mounted to the microscope or laparoscope housing and configured to capture a plethora of light rays from a volume of interest to each of the light field sensors, and a controller including one or more processors coupled to the display device and the multiple angle sensor capture sensors. When executed by the one or more processors the computer-executable instructions cause the one or more processors to perform an algorithm for rendering 3D video images of the volume of interest onto the display device including the steps of operating the multiple source perspective multiple angle sensor capture sensor arrays to capture a video frame perspective image data of the volume of interest with each multiple angle sensor capture sensor capturing a different angle and potentially overlapping image perspective of the volume of interest, generating a surface depth map of the volume of interest based on the corrected perspective view image data, generating Calibrated Volume of Interest (CVI) image data from each multiple angle sensor capture sensor by mapping each pixel in each corresponding video frame perspective of image data onto the generated surface depth map, and generating single source interpolated perspectives views for each multiple angle capture (MAC) sensors based on corresponding CVI image data for each sensor in the MAC sensor array. The one or more processors then perform the algorithm steps of merging the single or multiple source interpolated perspectives views and types of sensor information into a desired output perspective view of the volume of interest, generating formatted output data based on image parameters controlled by the controller of the input and display device, and displaying the desired output perspective view of the volume of interest on the display device using the formatted output data.

### BRIEF DESCRIPTION OF THE DRAWINGS

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIGS. 1-3 are perspective views of a lightfield imaging system, according to embodiments of the present invention;

FIGS. 4-8 are schematic views of the lightfield imaging system shown in FIG. 1;

FIG. 9 is a perspective view of a display visualization system that may be used with the lightfield imaging system;

FIG. 10 is a functional block diagram of the lightfield imaging system;

FIGS. 11-13 are flow charts illustrating algorithms used during operation of the lightfield imaging system to display computer-generated images; and

FIGS. 14-15 are exemplary illustrations of data files that may be generated by the lightfield imaging system when performing the algorithms illustrated in FIGS. 11-13.

FIG. 16 is a perspective view of a multiple angle capture sensor array used in a laparoscopic imaging device.

Corresponding reference characters indicate corresponding parts throughout the drawings.

### DETAILED DESCRIPTION

The detailed description of this lightfield device and all the features of this section will focus primarily on surgical microscope applications, although other embodiments are also described herein.

With reference to the figures, and in operation, the present invention is directed to a lightfield microscope imaging system for use in rendering three-dimensional (3D) video images of a source, which could be a patient or surgery site in real time. “Lightfield” or “lightfield 3D” or lightfield 3D holographic” is defined as a technology that creates a 3D model by capturing with camera and other types of sensors the direction, intensity, wavelength, and other features of rays in a volume of interest and spectrum of interest from different angles. While traditional lightfield sacrifices spatial resolution to gain angular information, our patent teaches a lightfield version that captures spatial information, while angular information is derived from the physical position of the known angle of the camera or sensor. While this invention's system is called a “Lightfield3D™ Microscope,” it's important to understand how it differs from traditional lightfield imaging technology. Traditional Lightfield Imaging use a single lens with a microlens array placed in front of the sensor to capture both spatial position (where light hits) and angular information (direction light is traveling). The microlens array splits incoming light rays to record different angles on different pixels. Thus, traditional lightfield technologies sacrifice spatial resolution to gain angular information and allow for post-capture refocusing but with limited perspective shift range which usually requires significant processing to extract usable 3D information.

Unlike the typical lightfield approach, this patent teaches the use of multiple discrete cameras and sensors arranged around a central axis. In this configuration each camera captures a complete high-resolution image from a unique perspective which creates a Common Reference Framework (CRF) through precise auto-calibration and then generates a depth map using either perspective analysis or dedicated depth sensors and then combines multiple perspectives through computational algorithm methods such as Elastic Convolution Transforms (ECT). In this manner this invention achieves a higher resolution output than a traditional lightfield video through computational super-resolution techniques. It also maintains high angular disparity due to the precise separation between cameras and sensors. This lightfield invention also teaches that at the signal level a controller can interpose different information from different types of sensors. For instance, information from a visual light sensor can be combined with information from a near infrared or near ultraviolet sensor to provide views from different sensors in the same video frame. In this configuration each camera is calibrated into a combined data source or common reference framework. In the next step the system creates a Calibrated Volume of Interest (CVI) into a combined signal; and then uses the spatial information combined with the signal information from the CVI to create a visual image. The resulting signal information from the CVI is converted to a digital video frame image is then combined into a series of video frames, and those frames are set to a certain frame rate which provides real-time streaming video. When these are viewed on a plenoptic monitor, the viewer can see a slightly different viewpoint depending on their position to the monitor presenting a real-time holographic 3D video of the source image(s). Volume of Interest, when used in this patent means the source, scene or surgery-site information. Plenoptic, when used in this patent means relating to the displaying computationally derived images from a given angular source or signal, from the CVI; and displaying the same with multiple images on the same monitor or display.

The key differences in this invention's lightfield technique is the acquisition method, where multiple discrete cameras and or sensors are used versus a single camera with microlens array. Another key difference is that there is a resolution advantage with this invention's method. This invention's approach maintains high base resolution and can achieve super-resolution, while traditional lightfield cameras trade spatial resolution for angular information. Another aspect of the invention is the enhanced display output. While both types of light field technologies can output to lightfield displays, the teaching of this patent has more flexibility in output formats and can generate enhanced views beyond what was directly captured.

In another enhancement of typical lightfield technology, this invention teaches that depth information can use various methods to create a high-resolution depth map, rather than extracting depth solely from angular information. Likewise, the perspective range of the physical separation between the sensors in the MAC sensor array provides greater perspective differences than can typically be extracted from a single-lens lightfield camera. Likewise, the perspective range of the physical separation between the sensors in the MAC sensor array provides greater perspective differences than can typically be extracted from a single-lens lightfield camera.

### Super Resolution

Super-resolution, as used herein, means digitally boosting resolution by geometric merit-based processing. Or super-resolution can be produced by Bayesian techniques. Or, super-resolution can be achieved by oversampling approaches. The result of super-resolution is that an image can be seen in a higher resolution than it was originally captured in. The lightfield imaging system 10 provides Interpolated Perspective views which exhibit Constructive Super-Resolution. An interesting consequence of perspective view interpolation is that an output perspective view which is produced by combining two or more source perspectives needs more resolution than the individual input views. If a field of interest contains areas with a slope relative to a single perspective view, where the surface is not perpendicular to the axis of view, that area will have reduced resolution proportional to the slope, while perpendicular areas will have full resolution. Perspectives with different axis of view will see these sloping areas with ether more or less resolution than the original perspective. This additional resolution can be preserved by the perspective interpolation process, if additional resolution is available in the constructed output. The magnitude of this increase is dependent on the angle of slopes in the surface of interest as seen from various axis of view, and the divergence of the various axis of the contributing perspectives. Even a fairly modest sample perspective axis distribution and a relatively flat surface of interest can require more than a linear factor of two increase in output resolution relative to resolution of input perspectives, requiring more than four times the pixels in the output to preserve the available information. A subtle but similar aspect is that each of the source perspectives has a different effective sampling grid due to axis tilt, relative to other perspectives, even when the surface of interest is completely flat and view axis separation is small. These viewpoints therefore contribute additional phase information as well, which can largely be preserved by using a higher resolution for the extracted perspective.

### Hyperspectral Imaging

The hyperspectral imaging system operates within an extended optical spectrum spanning from near ultraviolet (NUV) at approximately 250 nm through the visible spectrum (400-750 nm) to near infrared (NIR) at approximately 1000 nm, with particular emphasis on the 750-950 nm NIR window where biological tissues exhibit distinctive optical properties. The system employs a hybrid sensor configuration 22 wherein a portion of the standard imaging sensors are replaced with broad-spectrum sensors sensitive to wavelengths from 250 nm to 1000 nm. In the preferred embodiment, four of eight standard cameras are replaced with unmasked broad-spectrum sensors while maintaining compatible resolution and optical characteristics. Alternative configurations including but not limited to a 6+3 or 8+4 arrangements of standard and hyperspectral cameras may be implemented, or in some embodiments, complete conversion to broad-spectrum sensors. Narrow-band illumination sources 302, primarily light-emitting diodes (LEDs) with approximately 10 nm spectral width, provide specific wavelength illumination across the extended spectrum. Key illumination bands include primary visible wavelengths (450 nm, 550 nm, 650 nm+5 nm), critical NIR bands (810 nm, 830 nm, 850 nm) for hemoglobin transparency, and specific wavelengths for collagen detection (520-570 nm). The illumination system incorporates synchronization with sensor integration time, enabling pulsed operation for differential imaging techniques. Individual spectral bands can be independently controlled for intensity and timing, allowing sequential or simultaneous multi-spectral illumination patterns.

Optical filters and polarization components can add to the system's spectral selectivity. NIR pass filters, narrow band-pass filters, and an interchangeable filter system accommodate different clinical applications. Polarizers for light sources and analyzers for camera lenses enable cross-polarization techniques critical for birefringence detection, particularly in the 520-570 nm range used for collagen structure visualization. An expanded auto-calibration database 308 accommodates the extended spectral range, utilizing specialized calibration targets with spectral reference materials. The calibration process 306 measures sensor response curves for each spectral band, corrects for chromatic aberration across the extended spectrum, and calibrates polarization response characteristics.

The image processing pipeline incorporates separate paths for visible and extended spectrum data 318, with specific functions for cross-talk elimination between spectral channels and dark current/flat-field correction for each spectral band. Differential analysis algorithms process synchronized frames acquired with different illumination spectra to enhance feature extraction through background subtraction and comparative analysis 316. Then spectral mapping algorithms convert hyperspectral data into meaningful pseudo-color representations visible to the human eye 320. Tissue-specific spectral signature detection algorithms identify structures based on their unique spectral or biometric characteristics, with specialized functions for collagen birefringence detection, hemoglobin transparency mapping, and Cytochrome C detection for tissue viability assessment.

This lightfield system integrates the main imaging pipeline through data fusion processes that merge visible and hyperspectral information, incorporating spectral data into depth map generation 310 312, and then enhances the super-resolution processes with additional spectral dimensions. All processing maintains low latency (<20 ms total) using sliding-stripe processing approaches and Elastic Convolution Transform (ECT) operators for spectral transformations.

### ECT Image Processing

ECT is a method of resampling and remapping computational framework which transforms image data from one sample domain to another while implementing precise geometric corrections, convolution-based filtering, and frequency response modifications. The ECT allows traversal along arbitrary paths through source data, interpolation at sub-pixel locations using position-specific convolutions, and application of potentially unique processing operations at each sample point. This framework enables simultaneous correction of geometric distortion, modulated transfer function characteristics, and focus aberrations while maintaining sampling theory compliance and introducing minimal processing latency. ECTs are implemented in hardware to provide the high-speed, low latency processing necessary for real-time perspective correction, merging, and enhancement in multi-perspective imaging systems. The user interface provides predefined hyperspectral modes optimized for common surgical procedures including ILM visualization, ERM detection, neural tissue viability assessment, and hemoglobin-transparent viewing. Interactive controls allow adjustment of the balance between visible and spectral information, modification of spectral enhancement parameters, and selection of visualization options.

Visualization methods include blended or merged views from different sensors which can combine visible and spectral information, highlighting operator selected and then detected features, and opacity controls for spectral overlays. The system provides options for operator real-time feedback on spectral feature detection and adjustment of pseudo-color mapping parameters.

System integration considerations address lens transmission efficiency across the extended spectrum and slight differences in focal length between visible and NIR wavelengths. Compensation strategies for focal length variation include dedicated lens adjustments for NIR-specific sensors and computational focus enhancement techniques. Performance specifications include minimum detectable concentration thresholds for key biomarkers, signal-to-noise ratios for each spectral band, and minimum birefringence detection thresholds. Processing performance maintains consistency with the main system (minimum 30 fps) while adding differential analysis computation in under 60 ms due to algorithms and FPGA processing.

The implementation approach follows a phased development starting with integration of broad-spectrum sensors, followed by implementation of basic NIR illumination, addition of polarization components, and finally full integration of the complete spectral range and differential analysis capabilities.

Two primary clinical applications drive the system design: retinal surgery and neurological procedures. For retinal surgery, the system enables a non-dye visualization of an Internal Limiting Membrane (ILM) or through collagen birefringence detection, which is cross-polarization rotation for an enhanced visualization of Epiretinal Membranes (ERMs), and detection of metabolic activity through autofluorescence captured by visible light sensors. In the case of an ILM or ERM we see the tissue better by exciting the tissue with pulses of a specific wavelength from a narrow-band light source, and then For neurological surgery, the system improves visibility through blood using the NIR transparency window and differentiates between viable and non-viable neural tissue through Cytochrome C detection. Unique birefringent polarization effects in collagen structures near 520 nm wavelength provide a signature for ILM and ERM identification without dyes. Auto-fluorescence characteristics of NADH and flavins concentrated in these membranes provide additional identification mechanisms. Lipofuscin auto-fluorescence and Cytochrome C photo-reactivity in NIR provide additional markers for tissue identification.

Turning Blood into Water for Surgery Transparence

Hemoglobin, the primary oxygen-carrying protein in blood, presents a significant visibility challenge in surgical visualization due to its high optical absorption across the visible spectrum (400-750 nm). This high absorption results in substantial opacity of blood at even minimal thicknesses, severely limiting visibility of underlying tissues during surgical procedures, particularly in neurosurgery where bleeding is common and visualization of delicate neural structures is critical. Thus, the hyperspectral imaging extant in this system specifically addresses this challenge by exploiting a critical physical property of hemoglobin: its dramatic reduction in optical absorption within specific near-infrared (NIR) wavelength bands. A spectroscopic analysis indicates that hemoglobin exhibits approximately 100 to 1000 times lower absorption in the 750-850 nm range compared to visible wavelengths, with a particular transparency window centered around 810 nm. This physical phenomenon creates an opportunity to effectively “see through” blood that would be completely opaque in conventional visible light imaging.

The system implements this capability through precisely calibrated narrow-band NIR illumination sources centered at 810 nm (+5 nm), with additional supporting bands at 830 nm and 850 nm to provide complementary spectral information. These wavelengths are carefully selected at the sensor signal level prior to the step where a visual frame is created to maximize hemoglobin transparency while maintaining adequate tissue contrast and sensor sensitivity. Specialized processing algorithms enhance the hemoglobin transparency effect by creating a synthesized pseudo-color visualization derived from the NIR spectral bands. The system can selectively replace visible-spectrum luminance information that would otherwise exist in a visible video frame, and replaces the same with NIR-derived data while maintaining chrominance information from visible channels, and combining the two or more images creating a natural-appearing image that reveals structures behind or beneath blood.

Variable blending controls 318 allow surgeons to adjust the contribution of visible and NIR spectral components, enabling them to optimize the visualization for specific surgical situations. For superficial bleeding, a partial blend may be preferable, while for visualization through substantial blood accumulation, a higher weighting of NIR information to the combined image provides maximum transparency.

Differential spectral analysis further enhances blood transparency by comparing multiple NIR bands to differentiate between various blood states (oxygenated, deoxygenated, and partially clotted) and surrounding tissues. This analysis helps to distinguish between active bleeding, stagnant blood, and underlying tissues based on their distinct spectral signatures in the NIR range giving a surgeon areas which are either bleeding, stagnant blood or clotting in a visual reference, which can either be words or an outline color indication.

The blood transparency capability is particularly valuable during neurosurgical procedures where even minimal bleeding can obscure critical structures. By providing visibility through blood accumulation, through the combined video images, the system may reduce the need for continuous irrigation and suction to maintain visibility, potentially decreasing procedure time and reducing the risk of damage to delicate neural structures from these clearing techniques.

For neurological applications, the system exploits the approximately 100-fold increase in hemoglobin transparency in the near infrared (750-850 nm) to provide visualization through blood. Myelin birefringence effects are detected and visualized in the final video frames to easily identify tissue types such as nerve fibers. While in other instances, enhancers to the surgeon include methods such as identification of Cytochrome C presence which indicates viable nerve cells, enabling distinction between metabolically active and non-viable neural tissue. These can be represented by words, color, image overlays, lines, geometric shape, or other indicators.

The blood transparency capability can be combined with other hyperspectral features, particularly Cytochrome C detection, to provide simultaneous visualization of neural structures through blood while assessing their metabolic activity and viability for the surgeon to see in real-time. This integrated approach delivers critical information to the surgeon without requiring physical clearing of the surgical field.

In another embodiment of the invention, the hyperspectral system in this lightfield invention enhances the fundamental capabilities of the system by providing tissue discrimination capabilities beyond what is possible with visible light alone, while maintaining the core performance characteristics of low latency processing and high-resolution imaging necessary for real-time surgical applications. Moreover, application focus is enhanced with this invention's version of lightfield technology such that the system is specifically designed for surgical applications with features like Occlusion Resistance and tissue-specific enhancement (TSE). Occlusion Resistance is the capability to make part or all of surgical tools or other obstructions disappear or control the opacity of the object in the CDI which is fed into the final video stream.

In another embodiment of the invention the CVI model can be displayed in a stereoscopic fashion on a stereoscopic monitor or display like an augmented reality headset 70. In another embodiment of the invention, the CVI model can be displayed as a 2D version of a monitor or other display by calibrating the CVI model to output stereoscopic video 76.

In another embodiment, when used in an augmented or virtual reality headset, then the addition of headtracking input in which the headset sends it position and orientation data to the controller system in real-time; the system then computationally derives stereoscopic views precisely matching the uses current viewpoint in 3D space to display to the user. For instance, as a user moves their head the system continually renders new perspectives related to where the user's head is permitting the user to look around occlusions, such as tools or obstructions, examine the Volume of Interest from different angles, and move closer for a more detailed inspection or view without actually moving the camera sensor array which captures the source.

Lightfield based optical systems have shown great potential for supporting an expanded range of features, however, early examples suffered from low resolutions and excess processing time which prevented widespread application. The lightfield imaging system 10 of the present invention employs novel lightfield processing techniques to combine high resolution, deep field operation, low processing latency, freedom of perspective, and advanced image processing analytical tools such as phase contrast and other specialize filtering and feature recognition all in an integrated product.

Early lightfield systems acquired hundreds of perspectives simultaneously but this approach severely limited available resolution per perspective as well as quantifying available perspectives. Serious applications need both high resolution and complete perspective freedom over the area of interest. For realistic binocular vision and good hand-eye coordination, right and left perspectives with proper relative angular displacement are needed anywhere within the range of interest in real time. The lightfield imaging system 10 accomplishes this by acquiring a small number of high-resolution perspective views as well as depth information in the field of interest. This information goes through a high speed computational optics optimization process and renders any two perspectives for binocular vision with the desired viewpoint and ocular separation.

Support of emerging lightfield display devices is also possible by rendering a larger number of perspectives, but the current generation of lightfield displays operate at far lower resolutions than the lightfield imaging system 10.

In addition, critical hand-eye coordinated work using a computational and signal processing visual aid can provide tremendous benefits including vastly improved ergonomics which improves safety and accuracy. However, to achieve this benefit, any signal processing employed must be accomplished with very low latency. The lightfield imaging system 10 achieves this with ultra-high speed optical optimization, perspective interpolation and image enhancement processes.

A single high-resolution view of a surface of interest, combined with an accurate depth map allows computation of high-quality perspective views of a surface from a wide range of angles. There are two primary weaknesses of a single view approach. One is the inability to “look around” or “look through” an occluding object to see an occluded area of the surface of interest. The second weakness occurs when areas of interest are “steep” relative to the single perspective. Perspective view resolution in that “steep” area is reduced, and in extreme cases is entirely lost.

Using two perspective views greatly improve the ability to “see around” or “see through” occlusions, although there is still some dependence on shape and orientation. Two views address the loss of resolution for slopes along the axis connecting the views. Slopes with other alignments see less or no improvement. The use of multiple source perspectives to produce a single perspective introduces the need to weight the importance of each pixel in intermediate views. Slopes which approximate the view axis of a given perspective provide reduced resolution while slopes orthogonal to the view axis have resolution increased. Three views in an equilateral triangle improve slope resolution over a broad range of slope orientation, while a central view with surrounding views preserves resolution on flat surfaces. Above a modest number of source perspective views, the relative improvement from additional perspectives rapidly becomes less dramatic. The performance trade off soon prefers increased resolution of each view over more perspective viewing angles. A central view surrounded by a modest number of peripheral views is probably the ideal way to deal with occlusion, slope and resolution simultaneously.

The lightfield imaging system 10 also provides computational optimization of lens focus, chromatic alignment and modulated transfer function to support desired resolution, field of view, and depth of field of multiple perspective views. Whereas super-achromatic or apochromatic lens designs strive to focus a few specific color wavelengths at a specific focal depth and view axis alignment. This does not provide full color spectrum focus and consistent modulated transfer function at a range of depths or off axis perspectives. Therefor multiple types of computational improvements of lens performance are required over the desired depth of field and various perspectives is required.

The lightfield imaging system 10 provides precise geometrical color component focus over a substantial depth of field as well as a corrected Modulated Transfer Function to assure sharp images at any position, depth or orientation within the 3D volume of interest. Correction is enabled by the collection of optical system performance data during auto-calibration, and the application of that data and the depth data during operation, to the optimization of optical performance. This involves the real time collection of dynamic depth profile information, auto-calibration measurement of all sensor pixel positions and orientations relative to the volume of interest, and a complete geometric distortion map for each color component, and measurement of the realized modulated transfer function. Use of the optional single frequency color primaries mode allows even more precision. Optical correction utilizes the same Elastic Convolution Transform hardware and processing time used to generate the perspective interpolations. Optical correction and perspective interpolation are very similar operations and can be folded into the same transformations.

A Lightfield image acquisition approach using multiple source perspectives provides many novel capabilities, including the ability to see around or through occlusions such as tools between the microscope and the subject of interest. Combining optical calibration and optical performance optimization with the perspective processing pipeline synergistically enhances the Lightfield visualization benefits. The result is a microscope system which provides a dramatic width and depth of view and allows the subject volume to be viewed from any perspective and magnification without movement of either the subject or the microscope. Benefits resulting from the required multi-perspective processing include arbitrary pan and zoom of the viewing perspective and magnification, multiple forms of image resolution enhancement, and a calibrated volume of interest providing direct precision measurements.

The combination of Lightfield multi-perspectives, measurement and calibration of optical performance, iterative refinement of optimization, computationally corrected optics performance, and the signal quality and resolution advantages resulting from interpolated perspectives yield a new level of performance and a new class of instrument.

The following is a detailed description of the preferred embodiments of the disclosure, reference being made to the figures in which the same reference numerals identify the same elements of structure in each of the several figures.

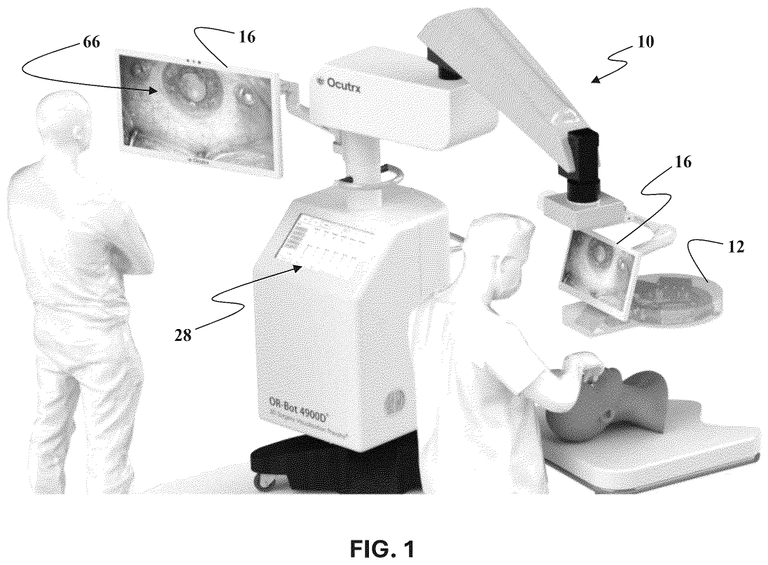

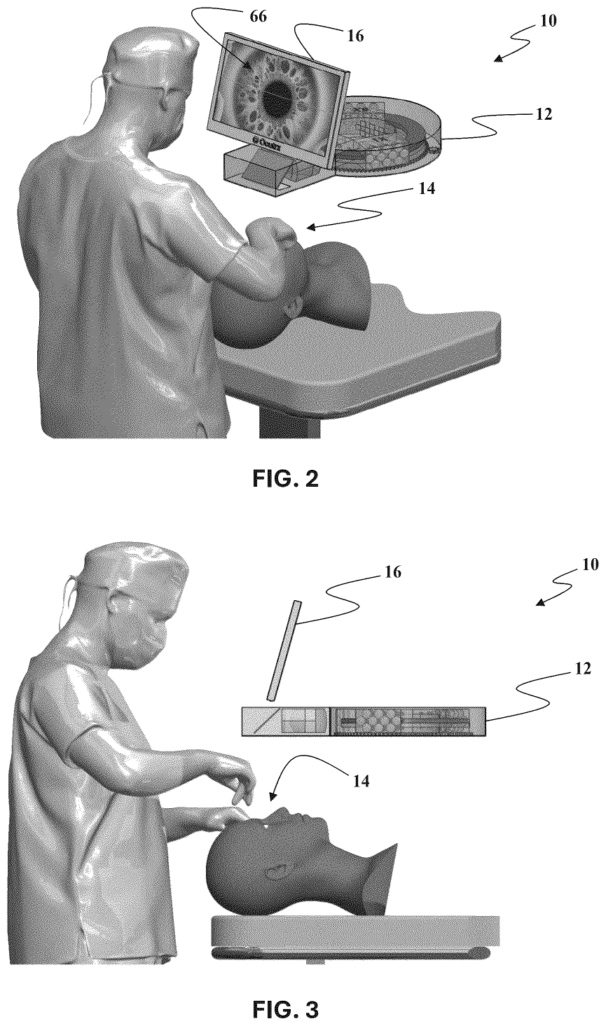

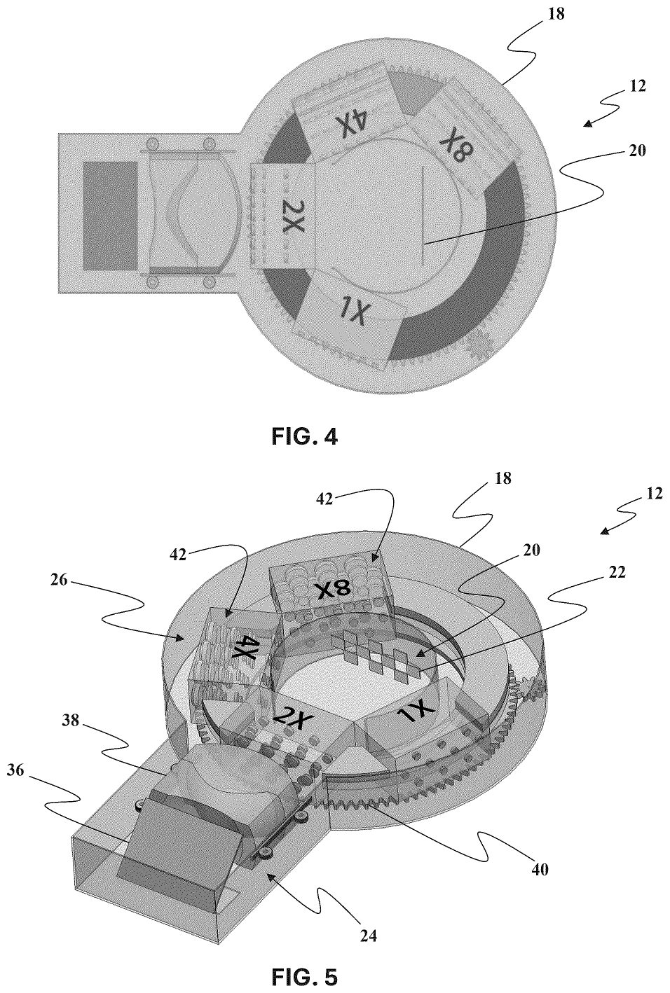

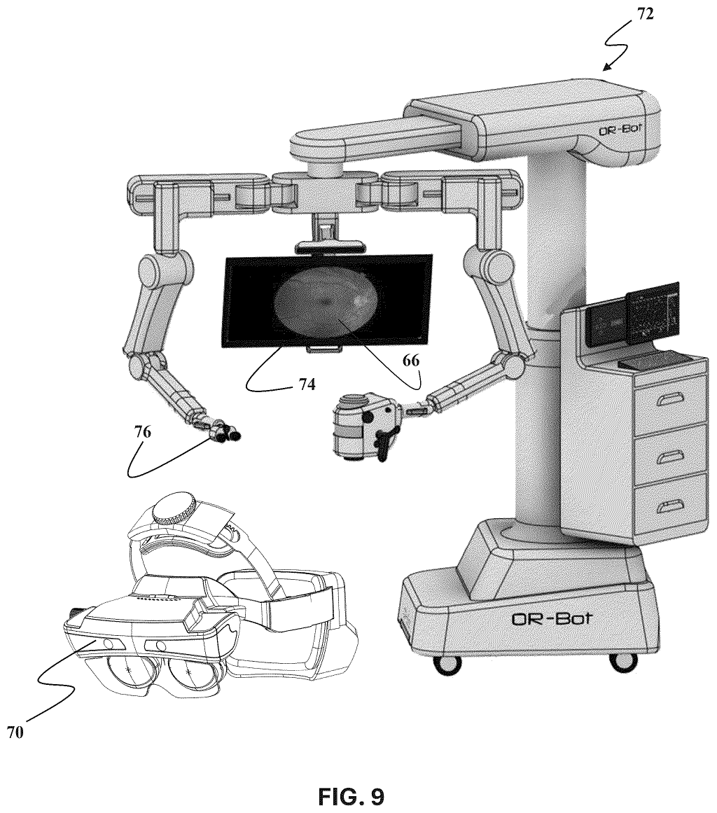

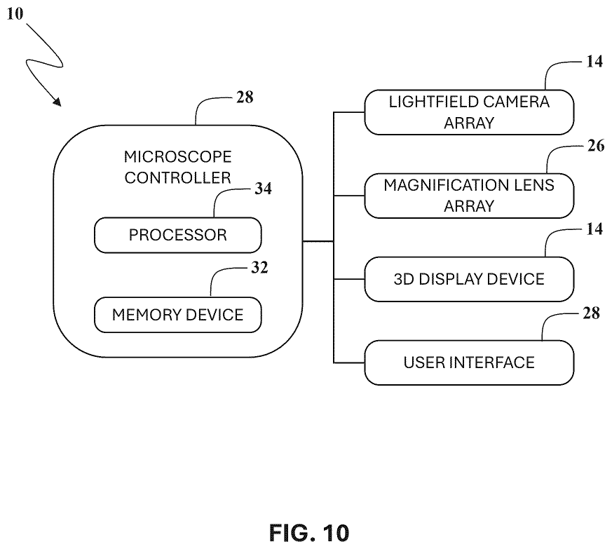

Referring to FIGS. 1-10, in the illustrated embodiment, the lightfield imaging system 10 includes a lightfield microscope assembly 12 for imaging the volume of interest 14 such as, for example, a retina of a patient's eye, and a display device 16 for displaying three-dimensional (3D) video images of the volume of interest.

The lightfield microscope assembly 12 includes a microscope housing 18, a MAC sensor array 20 including a plurality of MAC sensors 22 mounted to the microscope housing 18, an objective lens assembly 24 mounted to the microscope housing 18 and configured to direct light rays from a volume of interest to the multiple source perspective sensor array 20, a magnification lens array 26 mounted to the housing for directing light rays from the objective lens assembly 24 to the multiple source perspective MAC sensor array 20, a user interface 28 for enabling a user to operate the lightfield imaging system 10, and a microscope controller 30 coupled to the display device 16, the lightfield microscope assembly 12, and the user interface 28. The microscope controller 30 includes a memory device 32 for storing computer-executable instructions thereon and one or more processors 34 for executing the computer-executable instructions for performing an algorithm for rendering 3D video images of the volume of interest onto the display device 16.

In the illustrated embodiment, the objective lens assembly 24 includes a folding mirror 36 and an adjustable objective lens 38. The folding mirror 36 is configured to rotate the light path from a vertical orientation to a horizontal orientation, which allows for a minimal vertical profile of the lightfield microscope assembly 12. The adjustable objective lens 38 images the volume of interest such as a surgical field, at a distance of infinity while maintaining near diffraction limited performance across the entire aperture of the objective lens 38. As a result of these properties, sub apertures may be positioned anywhere across the objective aperture using identical arrangements of imaging lenses. The adjustable nature of the objective lens 38 allows for a change in working distance as well as a fine focus mechanism without impacting the performance of the sub aperture images. The objective lens 38 may be truncated in the vertical direction to minimize the profile of the lightfield microscope assembly 12.

The magnification lens array 26 includes a rotatable magnification changer 40 which includes a plurality of magnification lens assemblies 42 with each magnification lens assembly 42 being configured to images the surgical field at a particular magnification. Magnification lens assembly 42 samples the objective aperture of the objective lens 38 with a series of sub apertures. Each sub-aperture images the surgical field onto the corresponding sensor 22 in the MAC sensor array 20. The optical prescription of each sub aperture is the same within a corresponding magnification lens assemblies 42. The different magnification lens assemblies 42, however, each use a different prescription to achieve different magnification. For example, the magnification lens array 26 may include a first module configured to generate a 1× nominal magnification, a second module configured to generate a 2× nominal magnification, a third module configured to generate a 4× nominal magnification, and a fourth module configured to generate an 8× nominal magnification. The rotatable magnification changer 40 also includes a magnification turn table which rotates the magnification lens assemblies 42 to position a corresponding magnification lens assembly 42 along the optical path between the objective aperture of the objective lens 38 and the MAC sensor array 20.

The multiple source perspective MAC sensor array 20 includes a plurality of MAC sensors 22 arranged in a sensor array including a series of high-resolution lightfield sensors. Each sensor captures a high quality, real time, image with a perspective view corresponding to the location of its corresponding sub aperture. The multitude of perspective views enables reconstruction of the three-dimensional surgical field while being highly insensitive to small obscurations. During operation, the lightfield microscope assembly 12 may simulate a continuous zoom mechanism by performing up to 2 times digital zoom, before simultaneously switching the rotatable magnification changer 40 to position a corresponding magnification lens assembly 42 along the optical path between the objective aperture of the objective lens 38 and the array of corresponding MAC sensors 22 and reverting to no digital zoom.

In some embodiments, the lightfield microscope assembly 12 includes four main components including a folding mirror 36, a common main objective 38, an array of optical relays 26 and a sensor array 20. The folding mirror is used to redirect incident light so that the optical axis is aligned horizontally rather than vertically. The mirror is situated with ample working distance to allow for surgical operations. Given the working distance and the low profile of a horizontally oriented microscope body and taking into account the height of a surgeon sitting in front of a patient, this allows for the installation of a three-dimensional display system situated above the microscope body but still close to the natural height of the gaze of the viewer. The common main objective follows the folding mirror and is used to collimate the light from the object field. This element is well corrected for all optical aberrations over a large aperture. This means that the following components are insensitive to lateral displacement, meaning that a variety of optical relay array configurations with different stop locations can be used with identical lenses.

The array of optical relays takes advantage of the all-digital nature the microscope by allowing a mechanical mechanism to switch between different arrays exhibiting differing magnification. In order to simulate a continuous zoom mechanism, the image is digitally magnified until it reaches the zoom level of the next component of the magnification changer, at which point the digital magnification is reset. This allows for substantial reduction in the complexity, and therefore cost and size, of the optical relay array.

Finally, a magnified image of the object field is projected onto one of several individual sensors. Each sensor records a differing perspective of the object. Using the disparity between the sensors, a full three-dimensional model of the object field can be derived. This model consists of a depth map and a colored image superimposed on the three dimension depth map. In addition, the use of a fiducial grid of structured light can be projected onto the object and observed by the sensor array in order to improve the accuracy of the depth map.

Using microscopy to derive a three-dimensional model of the object field has significant application in computational analysis. This includes structure identification for use in identifying critical structures or pathologies, which can be added as an overlay to the model itself. Further, the depth information provided by the microscope enables robust collision detection which can be used to trigger visual, audible, or tactile signals to warn the operator of an impending collision. However, in order to apply the model to surgical applications, the field must additionally be projected in such a way that it provides sufficient resolution, latency, and depth cues to the human visual system in order for an observer to effortlessly and intuitively perceive the three-dimensional nature of the image in real time.

Of the various methods established to create a display with some or all of these capabilities, by far the most common is eyewear based stereoscopic display. This method operates by displaying an image with a different perspective in each eye, usually through the use of polarized glasses, thereby inducing the perception of binocular disparity, also known as stereo parallax, which the observer interprets as depth information. While providing binocular disparity, this implementation fails to convey the other physical depth cues, namely accommodation, convergence, and motion parallax. In particular, along with binocular disparity, motion parallax is a dominant depth cue when the distance to the image presented is small as is generally the case when performing surgery. Further, the need for polarized glasses causes significant inconvenience in the dependency on the glasses as well as the attenuation of ambient light, causing the surrounding environment to appear dim. Therefore, alternative methods of three-dimensional display are desirable.

In some embodiments, the three-dimensional display is an augmented reality headset. This method features two high resolution digital displays, each relayed to a different eye. The digital image is superimposed over a transmitted view of the real world. This creates the perception of binocular disparity from the digital image that can be used to locate the magnified three-dimensional model in three-dimensional space. This model can be positioned in relation to real world objects as seen through the transmitted view. While this technique does require the use of a head mounted display system, the user is no longer constrained to viewing a monitor, but has complete freedom of movement while maintaining a clear view of the magnified image. In this process, situational awareness is preserved thanks to the real world view. In addition, the effect of motion parallax can be replicated by using SLAM spatial positioning to vary the perspective relative to the three-dimensional model as the user's gaze and head position changes with natural body movements. Furthermore, this image can be displayed in relation to objects in the real world such that the motion parallax matches that of real-world objects. Ultimately this provides an interactive and intuitive fusion of reality with a magnified digital overlay.

The three-dimensional display may also be an autostereoscopic display featuring eye tracking. This method utilizes the magnified three-dimensional model to generate a pair of two dimensional images from perspectives corresponding to the intraocular distance. The images are directed to the viewer's respective eyes by a series of lenticular lenses affixed to a very high resolution display screen. Adjusting the display pixels used in each image, output image angles track the eye position of a viewer over time as the head moves and the eyes rotate. This maintains the perception of binocular disparity over time. As part of measuring the location of the viewer's eyes, a dynamic pair of images can be generated from the magnified three-dimensional model. These images track the movement of the viewer such that perception of motion parallax can be achieved. The three-dimensional display may also be an integral imaging display. This kind of display utilizes the magnified three-dimensional model to generate an array of images each representing a different perspective. The images are directed through a two-dimensional grid of lenslets so that each of the images form a distinct view of the object and the views are visible as a function of the radial angular displacement from the display normal. Each view subtends an angle smaller than that of the intraocular distance while maintaining continuity across the viewing range. Therefore, each eye sees a different view at any given position. Due to the spatial dependence of the image, this technique conveys the sense of both binocular disparity and motion parallax in three dimensions. The fact that this technique does not require any form of active alignment, such as aiming the images using eye tracking, means that there is no chance of delayed reaction to the movement of the viewer. Further, because the display does not have to direct the images to a specific set of eyes, it can be simultaneously viewed by multiple viewers.

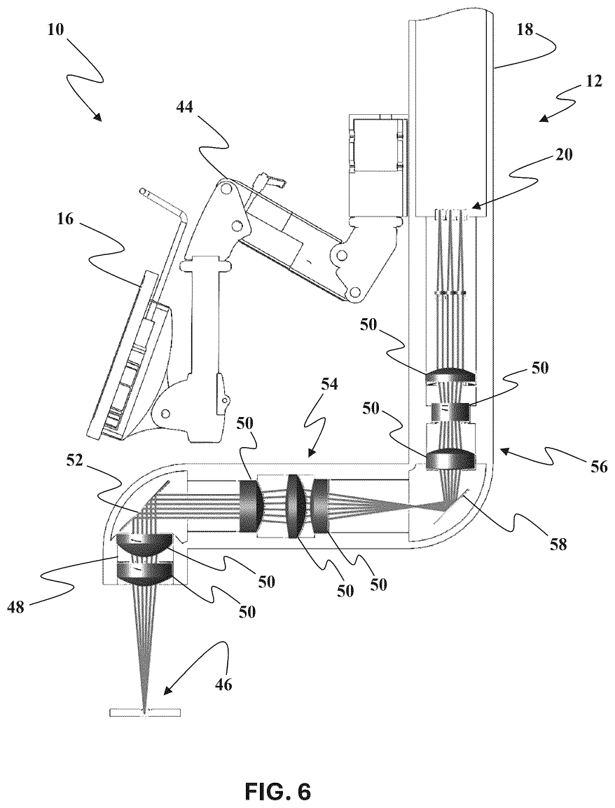

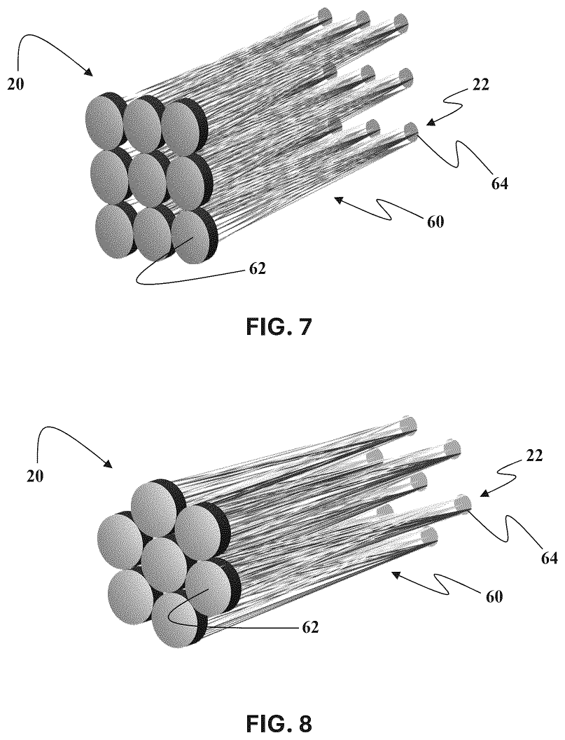

Referring to FIGS. 6-8, in some embodiments, the lightfield imaging system 10 may include a holographic display 16 mounted onto an articulating arm 44, with the microscope housing structure 18 is positioned over an object viewing plane 46. The objective lens assembly 24 includes a collimating objective 48 including two aspheric lenses 50 and a first turning mirror 52, an focusing relay 54 including three aspheric lenses 50, a pupil forming relay 56 including a second turning mirror 58 and three aspheric lenses 50. Each MAC sensor 22 may include a lens sensor pair 60 including a focusing lens 62 and an image sensor 64. In some embodiments, the multiple source perspective MAC sensor array 20 may include a nine-element orthogonal array (shown in FIG. 7) and/or a seven-element hexagonal array (shown in FIG. 8).

In some embodiments of the super stereo/polyscopic video microscope, an array of sensors is used to image a magnified object in real time through a common main objective and relay system. The overall imaging system consists of four complementary subsystems which include a collimating objective, a focusing relay, a pupil forming relay and a camera array.

Each subsystem is designed to perform a specific function, separately but complementary to the entire optical system. Therefore, anyone of the subsystems could be replaced in order to change the parameters of the optical system without compromising performance, for example, the objective lens could be exchanged in order to change the field of view of the system. Magnification of the entire system is set so that the desired field of view of the object fills the sensor area. By changing individual subsystems, the magnification of the overall optical system can be altered while keeping the working distance of the camera array constant. Therefore, the effective field of view could also be altered. Alternatively, the system could be configured to incorporate a zoom system that allows the magnification of the system to be altered dynamically.

The collimating objective consists of two aspheric singlet lenses which serve to collimate light from the object plane. Parts of the object that are located slightly before or after the effective focal length of the collimating objective will slightly diverge from the properties of the collimated light. Ultimately, these parts outside of the effective focal length will result in a blurred picture at the sensors which therefore defines our depth of field. Because the system is nominally collimated, there is an opportunity to fold in light which can be used for illuminating the object for collecting additional information as in Optical Coherence Tomography (OCT) without interfering with the function of the microscope. Additionally, an infinity corrected zoom system can be installed to change the field of view of the objective such that a varying magnification is detected by the sensors.

The focusing relay consists of three aspheric singlet lenses and is designed to collect the collimated light from the collimating objective and cause it to converge through the actual aperture stop of the system and form an intermediate focus. The placement of the aperture is critical because it will be used to define the location of the focusing lens array and the size is important because the image of the aperture stop must match/exceed the maximum extent of the array of focusing lenses.

The pupil forming relay consists of three aspheric singlet lenses and collimates the light from intermediate focus. In addition, it creates an image of the aperture stop at a location that is in front of the last lens of the group forming an exit pupil which is external to the rest of the microscope system. The distance between the last lens and the exit pupil determines the location of the camera array.

The camera array consists of a group of lens sensor pairs which each form an individual camera system composed of an aspheric singlet lens and an image sensor which is capable of capturing both still and moving images at high resolution. Each lens in the lens sensor pair focuses collimated light onto an associated sensor. The sensors are located at the exit pupil plane of the pupil forming relay in order to efficiently gather the incident light. The array can be any number of three or more lens sensor pairs. The sensors can be arranged in any of several or multiple configurations such as nine lens sensor pairs in an orthogonal arrangement or seven lens sensor pairs in a hexagonal arrangement or mixed sub aperture array in which a large central aperture is incorporated to provide a higher lateral optical resolution with smaller apertures arranged around the larger aperture. In order to capture as much light as possible, the size of the lenses should be comparable to the footprint of the sensor and supporting architecture. Additionally, the focal lengths of the lenses may vary so that they are imaging slightly different object planes which could be used with image processing to increase the depth of field. Alternatively, this can be achieved by varying the distance of the lenses to the sensors across individual lens sensor pairs so that they image slightly different object planes. Varying both the focal length and the distance of the lenses to the sensors can be used to stagger the supporting architecture of the sensors without varying the object plane. In an alternative configuration, a prism or a group of mirrors is used to split the light incident on each lens sensor pair to generate additional perspectives.

This system may be used to gather images of the object from a multitude of perspectives. Therefore, the plenoptic function of the lightfield may be constructed by comparing the location of features on each image using image segmentation techniques. These segmentation techniques include however not limited to edge detection segmentation, threshold segmentation, clustering and various convoluted or deep neural networks.

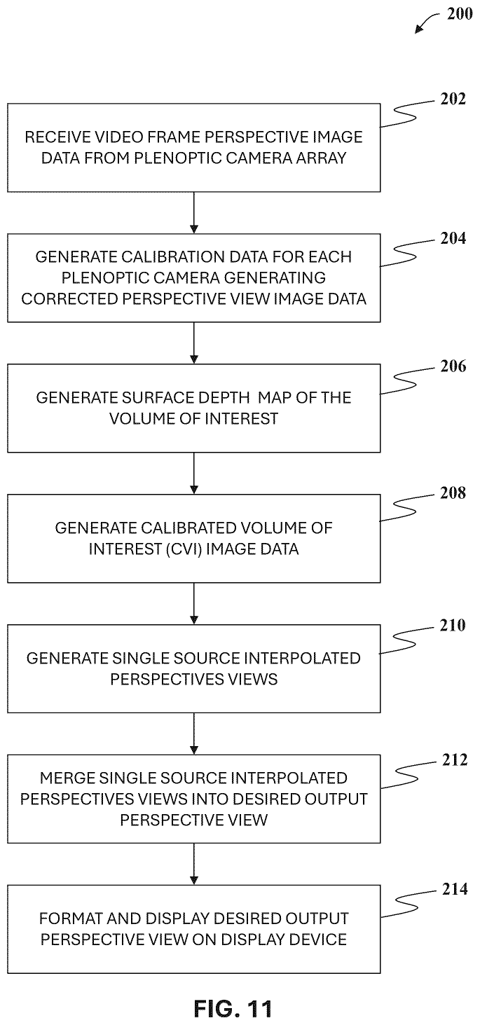

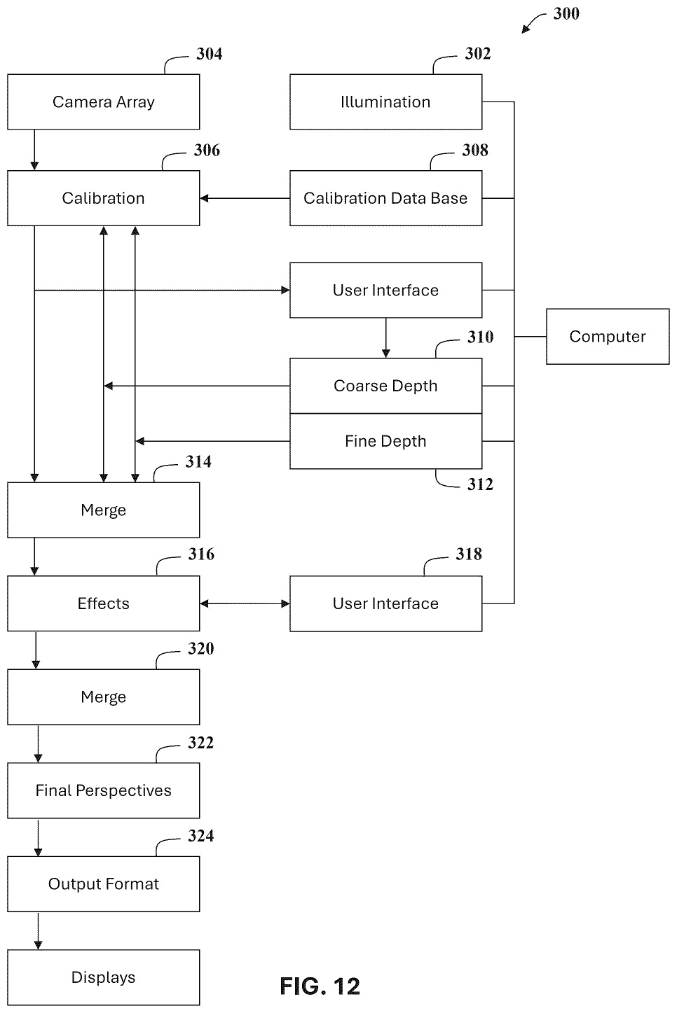

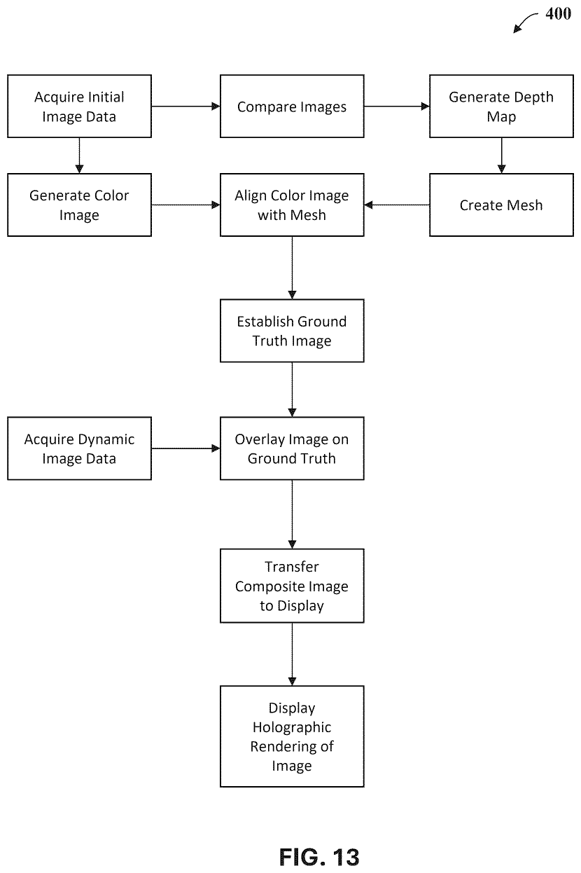

FIGS. 11-13 are flow charts illustrating algorithms 200, 300, and 400 executed by the one or more processors 34 for operating the lightfield microscope assembly 12 to display computer-generated images to the user using the display device 16. The algorithms 200, 300, and 400 include a plurality of steps. Each algorithm step may be performed independently of, or in combination with, other algorithm steps. Portions of the algorithms may be performed by any one of, or any combination of, the components of the lightfield imaging system 10.

In the illustrated embodiment, in algorithm step 202, the one or more processors 34 operate the multiple source perspective MAC sensor 20 to capture a video frame perspective image data of the volume of interest with each sensor in the MAC sensor array 20 capturing a different overlapping image perspective of the volume of interest.

In algorithm step 204, the processor 34 generates calibration data for each sensor in the MAC sensor array 20 indicating optical performance and physical sensor orientation of each sensor in the MAC sensor array, and generates corrected perspective view image data for each sensor in the MAC sensor array 20 based on the captured video frame perspective view image data received from each sensor in the MAC sensor array and the calibration data.

For example, the processor 34 may be programmed to perform Auto Calibration of Optics Performance (OP), View Geometry (VG) and Depth Map (DM). This is an operation done at startup which collects data to allow very precise placement of the field of interest, and all depth and image sensor components. The processor 34 then collects a detailed map of lens performance including chromatic geometric distortion, depth of focus and focus blur function, and a geometric map of the optics modulated transfer function including tangential and sagittal details. This information is used as the basis for computing all geometric relationships and processing requirements as well as optics performance optimization including geometric distortion by color component, distortion due to depth of focus, and modulated transfer function correction.

The mechanical fixture holding sensors, optics, and depth measurement components maintains alignment of the critical components to typically a few 10s of microns. System startup includes an auto-calibration process which produces a mathematical model of relative position and alignment of components to roughly one micron or less. This model is used as a frame of reference to tie all the relative positions and orientations together. This database is then used by the following operations to compute the desired lightfield perspectives.

Auto-calibration enables extensive optimization of optical performance and simplifies processing to enable the required high processing speed. Auto-calibration of all aspects of optical performance and physical sensor orientation allows multiple perspective views to collaborate constructively during operation. Collecting this information allows optical performance to be computationally improved while greatly simplifying and speeding the required processing. Any system used in the hand-eye coordination loop must keep latency to an absolute minimum making processing speed essential.

Advantages and Corrections enabled by calibration. Even the best quality lenses fall short of mathematical perfection. It is also challenging for a large assembly of components to maintain sub-micron alignment through manufacturing, shipment, use and maintenance. Auto-calibration allows physical precision and optical near perfection to be achieved in daily use. All critical physical and optical parameters are measured during calibration as well as evaluating the effectiveness of corrective processing actions such as increasing the range of useful focus throughout the volume of interest, correcting local color component frequency response and geometric distortion. This vastly improves computational correction effectiveness and quality while keeping computational processing requirements reasonable and processing latency low. As a result, practical day to day performance characteristics greatly exceed what would otherwise be possible.

Measurement of sensor orientation and optical performance. The calibration process measures effectively all optical and sensor characteristics including orientation, sensor pixel quantum efficiency and linearity and lens geometric distortion and modulated transfer function by region and separately for each color component over the entire volume of interest. Spectral characteristics and energy distribution of light sources and projected fiducials within the volume of interest are also collected.

In algorithm step 206, the processor 34 generates a surface depth map of the volume of interest based on the corrected perspective view image data. For example, the processor 34 performs Depth Map (DM) Acquisition as a continuous process operating at or above the frame rate frequency of the image sensor system. The processor 34 uses auto calibration information combined with current depth information to provide a high resolution depth map of the surface of interest which is current for each frame time.

The Depth Map is the distance from a reference plane at the optical sensor system to the surface of the object at the field of interest. Several methods are available to measure the depth field to the desired resolution. The use of near infrared fiducial pattern projectors and image sensors is described here. To minimize optical occlusion by hands or tools in and around the optical path, three projectors and three sensors are used. Each projector uses a point source and an x-y grid which appears as a square grid on a flat surface perpendicular to the optical axis. Grid spacing contracts as the surface approaches the optical sensor system. At maximum fiducial projection height and maximum depth to surface of interest, the grid spacing is at its maximum, which is often set to 1 mm. At maximum fiducial projector height and minimum useful depth, the grid spacing is approximately 80% of the maximum spacing. Lower fiducial projector height can increase the range from minimum to maximum spacing. Each of the three fiducial projectors is rotated 30 degrees around the optical axis, so the x grid lines are nominally at 0, 30, and 60 degrees while the y grid lines are at 90, 120, and 150 degrees. Any one of the three fiducial projectors and sensors is adequate to compute the depth map, providing good tolerance to obstructions. Individual angles +/−15 degrees are selected by frequency transform mask filtering, and spacing is converted to a depth map, the six sets of data are combined with the two highest and two lowest values discarded and the remaining two averaged. The data is low pass filtered to provide the result for this frame time. The grid resolution and field size result in relatively small data sets compared with perspective view images, allowing them to be processed rapidly. The entire depth perception system can be operated at a multiple of the optical frame rate, or phase shifted to provided new depth data at the beginning of image data processing to reduce latency.

The processor 34 then performs Depth Map and Perspective Views to Geometric Distortion Map (GD) as a geometric transform which occurs at each frame time. The processor 34 utilizes the auto calibration data which precisely positions the image sensors relative to the field of interest, and the depth map data, to compute the required geometric distortion map required to project each view onto the desired interpolated perspective view.

Depth Map (DM) to Geometric Distortion Map (GDM). Auto calibration data allows the geometric mapping of individual pixels of each perspective view to the corresponding region of the field of interest at maximum depth. Adding Depth Map information allows mapping to the actual surface presented by the object of interest. This is because reducing the depth from maximum changes the angle of the view slightly. If a binocular view is needed, this this is done for each real perspective which is a neighbor of the desired view. The approach can work with one or two reference perspectives for each desired perspective, but the idea number is six.

Processing Latency Depth Map rate of change is expected to be relatively slow and can tolerate more latency than perspective extraction. Removing Depth map computation from the critical latency path appears reasonable. If the second previous frame is used for depth calculation, the Depth Map data lags the current frame by two frame times, and assuming image acquisition at 100 frames per second (fps), Depth Map information would be 20 milliseconds old when used for perspective extraction. This allows perspective extraction to lag current frame acquisition by a total latency less than 50 milliseconds, including a 10 ms frame acquisition time. Display subsystem latency would add an additional latency delay.

In algorithm step 208, the processor 34 generates a calibrated volume of interest (CVI) image data for each sensor in the MAC sensor array 20 by mapping the corrected perspective view image data onto the generated surface depth map.

For example, the processor 34 may generate Geometric Distortion Map & Optics Performance Dataset to Elastic Convolution Transform control Dataset (ECTD). This operation occurs at each frame time. The processor 34 uses the Geometric Distortion map and the Optics Performance Dataset for each input Perspective View to generate an ECTD to drive an elastic convolution transform to convert that perspective and correct optics performance for each desired output perspective. Each individual pixel color component has a unique transform operation unique to its situation in the overall geometry and optical performance correction requirements. A unique ECTD is generated to process each input Perspective View, and multiple Perspective Views are typically required for each desired Interpolated View. Two Interpolated Views are required for binocular vision, and typically many IVs at a lower resolution are required for output to a lightfield display device).

Geometric Distortion Map to Elastic Convolution Transform control Dataset (ECTD). A Convolution Transform is a degenerate version of the more general ECT. A CT applies a convolution operation to the neighborhood of every pixel component in an image to implement a frequency response filer, edge detection, MTF correction, or similar convolution operation. In a stream based data flow a convolution transform adds a few lines of processing latency. For example, a 9×9 convolution transform performs 9×9×3 or 243 multiply-adds per pixel and adds 5 line times of processing latency. An ECT is a generalization of the Convolution Transform. The path through the source image is specified for each output line, and may be any line, arc, or path, which may be discontinuous. The convolution coefficients applied can be changed for each pixel, and can come from a large coefficient set. In addition, the size of the input and output image do not need to be the same. An ECT is used for geometric distortion correction, resizing, reshaping, variable frequency response filtering by pixel, variable rate geometric interpolation, and a large number of other operations including video effects and computational optics. A 10×10 ECT with the same input and output image size would typically add 5 lines of latency, depending on edge treatment options, plus the worst case vertical non-locality excursion. In most applications the worst case top and bottom non-locality is small, and worst case latency is usually in the range of 4 to 24 line times, but in the case of extreme geometry changes can be large. The ECTD is the dataset with controls the ECT path through the source image, providing the information on where to apply which convolution, and how to deal with edges. The ECTD specifies everything need to convert the input image to the desired output image.

Optimization of optical performance and conversion to a calibrated representation. During normal operation, a depth map of the surface of interest within the volume of interest indicates where a particular pixel in a particular view from a specific perspective view intersects that surface. This allows a specific geometric, MTF, and focus correction to be applied to that pixel. The Elastic Convolution Transform is well suited to performing such localized operations at high speed, potentially correcting sensor gain, linearity, MTF, focus, and geometric distortion with extremely low latency.

A Calibrated Volume of Interest (CVI). Converting all perspective views into the Calibrated Volume of Interest (CVI) reference frame is critical to employing these corrected source perspective views as an effective team to increase resolution and provide the correlated data to generate and output any number and orientation of interpolated perspective views.

Determining the surface depth map within the Calibrated Volume of Interest (CVI). A depth map of the surface of interest is key to simplifying the mapping of corrected perspective views into the calibrated volume of interest, and the remapping to interpolated perspectives. There are a number of approaches to generate the required depth map ranging from separate IR fiducial pattern emitters and sensors to approaches which utilize the primary image sensors. If fiducial or modulated amplitude emitters are used, it is desirable to use two or more emitters to better tolerate occlusions. Angular rotations of modulated patterns or use of individual color components can be used to discriminate between various emitters, allowing multiple depth results to be compared for improved robustness and accuracy. Modulated patterns superimposed on general illumination or color primary illumination can provide a suitable depth solution in constrained applications.

Exploit narrow spectrum illumination for improved correction. Utilizing narrow spectrum color primaries with a half power width on the order of 5 nm, rather than continuous spectrum primaries on the order of 150 nm wide can improve optical lens performance by reducing broad spectrum based geometric spread of image information. Sharper focus, greater depth of focus, reduced geometric distortion, improved correctability and better image detail result. Due to computational correction, narrow color primaries do not necessarily need to be centered on optical chromatic zero crossings, but can be chosen for other reasons such as tissue or sensor response, if desired. Display primaries are based on human color perception and industry standards. Converting from a set of narrow pseudo primaries to the output display color space typically requires color space conversion.

Optimization of optimizations. Many of the optical optimizations are inverse convolutions which do not have deterministic closed form solutions. Auto-calibration allows the system to experiment with various alternate corrective approaches to determine the best corrective performance possible. Corrections are applied to the source perspective view sensor data and can vary pixel by pixel and by depth of field and color component as needed to correct local error. Corrections can be a function of location in the volume of interest where the perspective viewing angle intersects the surface depth map. For example, this allows focal depth corrections to vary depending on distance above or below preferred focal distance for the specific pixel color component. MTF and geometric corrections operate in a similar way. Although the number of individual correction convolutions could in theory become vast, typically a few hundreds or thousands suffice for each lens.

In algorithm step 210, the processor 34 generates single source interpolated perspectives views for each sensor in the MAC sensor array 20 based on corresponding CVI image data for each sensor 22 in the MAC sensor array 20. For example, the processor 34 may generate the single source interpolated perspectives views for each sensor in the MAC sensor array 20 using Elastic Convolution Transforms.

For example, the processor 34 may perform Perspective View (PV) Acquisition and Corrected Perspective View (CPV) Generation. This operation occurs at each frame time. The processor 34 applies an ECT operation controlled by the specified ECTD for each input Perspective View, producing an output Corrected Perspective View. The CPV output will typically be represented at a higher resolution than the PV input to preserve information. Each CPV also acquires an additional pixel component in this process, which indicates the relative information significance of this pixel, which is an important factor when combining CPVs to produce each final Interpolated View.

Perspective View (PV) Acquisition to Corrected Perspective View (CPV) Generation. Each perspective view captured by an image sensor will potentially need lens roll-off compensation, noise filtering, geometrical distortion correction and modulated transfer function correction specific to each color component and location. Then convolution Bayer decoding and filtering. Using one CT stage and two ECT stages results in about 25 lines of total latency, depending on worst case geometric distortion correction required.

In algorithm step 212, the processor 34 merges the single source interpolated perspectives views into a desired output perspective view 66 of the volume of interest. For example, the processor 34 may generate Corrected Perspective Views to Interpolated Views (IV). This operation occurs at each frame time. The processor 34 merges the set of CPVs for each desired perspective output, preserving the available image resolution in each area of each output view in the process.

Corrected Perspective Views to Interpolated View (IV). The CPVs generated from the PVs neighboring the desired interpolated view will each need to go through an ECT programmed with a specific ECTD map to produce the desired result. After being geometrically transformed, the resulting IV image each represents that neighbor's version of the desired view, which should now align with other IVs for this output perspective to a sub-pixel level. If a single source perspective is available, the resulting IV from that view is the final view. If multiple source perspectives are utilized, the multiple IVs produced for each of the final output views must be merged in a way which preserves the best case resolution of each region of the image. This is done using an extra parameter in the ECTD program which indicates the weighting of each output pixel in each IV generated. This weighting is determined by the map of geometry of the source perspective and the map of the geometry of the surface of interest. The IVs for a given view are effectively averaged using that weighting factor for their relative significance, optimizing resolution throughput the resulting image.

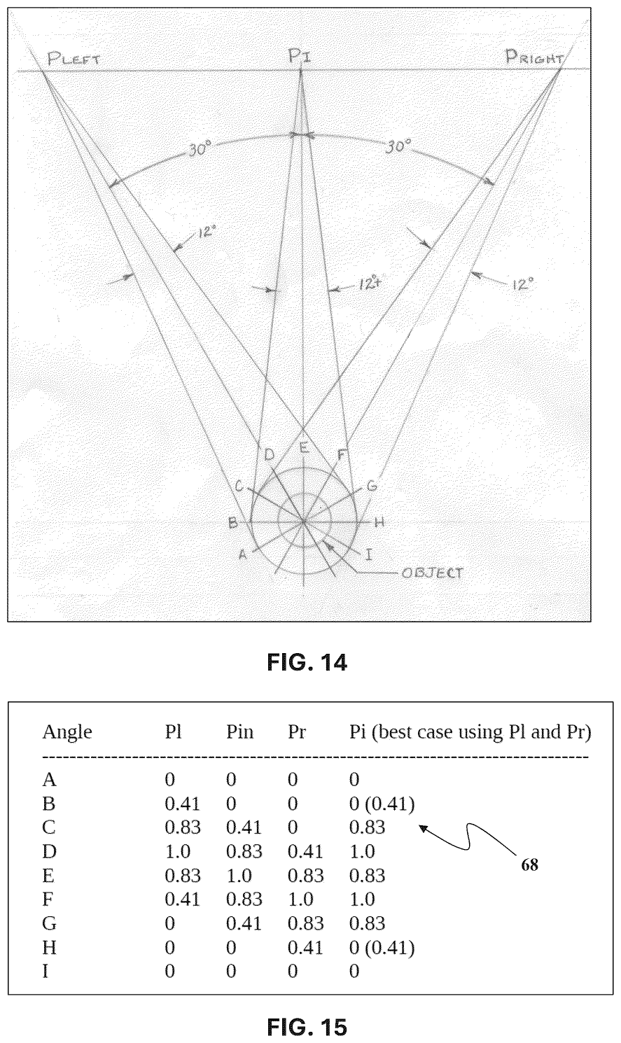

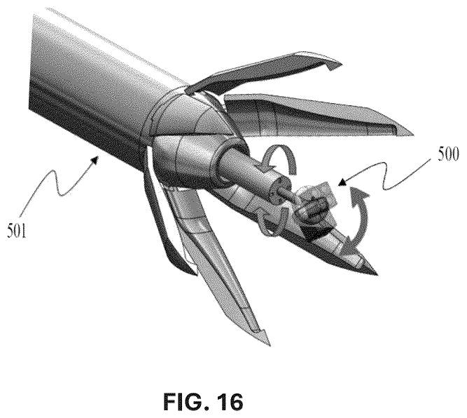

For example, as shown in FIGS. 14 and 15, in some embodiments, the processor 34 may assign a figure of merit value 68 for each pixel of each sensor in the MAC sensor array 20 indicating a significance of a corresponding pixel to the desired output perspective view and generate each single source interpolated perspectives view including a figure of merit value for each pixel. The processor 34 then merges the single source interpolated perspectives views into the desired output perspective view based on each figure of merit value of each pixel.

In some embodiments, the processor 34 may determining a relative location of each pixel with respect to the volume of interest based on the surface depth map and assign the figure of merit value for each pixel based on the determined relative location of each pixel.

Perspective Interpolation. Perspective interpolation is implemented by selecting the desired corrected source perspectives which are typically, but not necessarily source perspectives surrounding the desired perspective. Assume the source perspectives have been corrected into a common reference space. Using the surface depth map, ECT programs are generated for each of the source perspectives which will convert that source into a prototype version of the desired perspective. The prototyped desired perspectives include their potential information contribution to the desired perspective, plus the addition of a per pixel component representing the figure of merit for its corresponding pixel value. The figure of merit indicates how significant the pixel is to the desired perspective. A small range of merit values are typically adequate. For example, merit values of 0, 1, 2, or 3 indicating merits of none, poor, fair, and good is usually adequate. Once prototypes are generated using each of the desired perspectives, they are merged into an output image where each pixel is represented by the average value of the highest merit of the source prototypes.

There are advantages using input perspectives which both close and far from the desired perspective. As shown in FIG. 14 an object is observed from two perspectives, Pl (left) and Pr (right), with an interest in producing a Pi (interpolated) perspective. A through I represent ranges of surface angles which may be encountered. Due to geometric shortening, each of these surface angles is seen with a different resolution from each perspective. Pin (input) is a hypothetical input perspective at Pi for comparison to interpolated Pi results. The worst case relative resolutions (expressed in a range from 0 to 1) for each 30 degree step in surface angle from each perspective is shown in FIG. 15.

Useful resolutions at Pi (P interpolated) are actually higher than a hypothetical Pin resolution would be, except for surface angles in the neighborhood of E. A perfectly flat surface of interest would be “all E” and in that case Pi would exhibit a 17 percent lower resolution than Pin. This can largely be solved by providing additional source perspectives closer to Pi, or above and below Pi. For slopes near C, D, F and G, the interpolated Pi view has potentially much higher resolution than Pin. The maximum super resolution in this example is 2× in and around angles C and G. To actually represent this super resolution, Pi resolution would need to be twice that of Pin. Potential super resolution increases with increasing perspective separation angles. To retain and utilize the available resolution, Pi needs to be generated at twice the source resolution.

Low latency processing is essential to high speed analysis and performance optimization. Latency is the time that the image stream is delayed. Very low latency is required in the hand-eye coordination loop. Image sensor delay can be minimized by utilizing a rolling (continuous) data readout and display delay can be minimized by using a synchronous display phased appropriately for processing delay. Even with this finesse applied, image integration time and output display requirements leave very little time for processing. The current approach calculates the surface map slightly ahead of the image perspective processing by using earlier image sensor data. Input perspective correction and conversion to the Calibrated Volume of Interest (CVI), followed by generation of single source interpolated perspectives, then merge of perspective sources, and finally display output can occur with total processing latency a fraction of one frame time. To minimize latency, Elastic Convolution Transforms (ECT) are heavily relied upon as well as their ability to typically folding many operations together into each ECT step. Three stages of ECT are in the critical latency timing path, first to apply corrections, second to generate single source view interpolated output perspectives, and third to merge those prospective prototypes into output perspectives and finally formatted output.

Characteristics of an Elastic Convolution Transform (ECT). Elastic Convolution Transforms were developed to address the need for elastic (arbitrarily stretched or compressed image size) transformation of a source image to a destination image at minimal latency. Latency is determined primarily by data locality requirements. Assuming source and destination are processed in the same geometric orientation, locality is primarily dependent on the most extreme elastic distortion required, and the size of any required local convolution or transform. For typical optical “perfecting” operations, locality and hence latency can be well under 1/10 of a frame time. Geometric and MTF corrections can be applied, the image can be reshaped and resized, Bayer decoding and color conversions can be performed, and various filtering operations can be applied in the same process and latency.

Characteristics of Signal Resolution Representation (SRR) (QPE & ACQ). Images typically contain a great deal of quantum lightfield noise due to the random distribution of captured image illuminating photons, as well as thermal noise generated internal to the image sensor. As a result, lower frequency information is represented statistically rather than locally and the entire image frequency spectrum contains a great deal of noise information. This is the normal state of affairs and does not bother us visually because the visual cortex is so good at dealing with this aspect of reality. However, for relatively local operations such as color decoding and geometric and MTF corrections or any relatively local operation, a better representation of signal resolution and noise magnitude is desirable to avoid “baking the noise into the result”. A SSR representation utilizes sampling theory to optimize locality and resolution while minimizing noise energy. This is exactly what is desired for the optimization processes. A SSR transform can be folded into the ECT process, resulting in output signal resolution exceeding input resolution while noise energy is reduced. An optimal SSR representation of a 1K×1K image sensor with a 10 bit output and 16 quanta of average noise would see an increase of resolution to 16 bits or 30 dB at f0, and a typical reduction in noise magnitude on the order of 24 dB at Nyquist.

Locate probable occlusions “above” the surface of interest. Related to surface depth, detecting occlusions above the surface of interest and outside the volume of interest and determining which source perspectives may be involved is desirable. If nothing is done, depending on perspective merge, this would produce output which would appear to see through the occlusion with some transparency. If detected and a partial or complete perspective was eliminated, the occlusion could be effectively invisible.

Filter and Enhance images as desired. A number of popular image filtering and enhancement operations can be folded into the processing pipeline. The ECT is capable of phase contrast filtering which can provide dramatic results in some situations and is popular in microscope applications. Homomorphic filtering can be used to dramatically expand contrast of a specific region of color or luminance. General reshaping of the Modulated Transfer Function is available as well.

Exploit geometric and sampling theory based super-resolution. The combination of individual prototype interpolated perspectives (interpolated perspectives derived from a single source perspective) to produce the combined or final interpolated perspective exhibits two forms of potential super resolution. One is a direct consequence of geometric construction. When a surface of interest has regions at various angles, various viewing perspectives will provide differing resolutions for those regions. Regions which are nearly perpendicular to a particular perspective view axis will have high resolution. Regions which are nearly parallel to a particular perspective view axis will have very low or no resolution. If an interpolated view has a relatively low resolution region for which high resolution data is available from another view, then to preserve this available resolution, the interpolated view will need to be resampled at a higher resolution to “make room” for the higher resolution region data. As the cone of view and/or surface angles increase, this effect increases, and can become quite large. If output resolutions higher than source resolutions are desired, doubling the interpolated perspective resolution by a factor of 2× or more seems appropriate to provide for most of this effect.

The sampling based super-resolution mechanism depends on the fact that interpolated perspectives will be based on different pixel pitch due to mechanical offsets and viewing angle. These alternate sample grids each address some of the sampling phase and signal ambiguity which exists in a single perspective. Taking advantage of this by again utilizing a higher interpolated perspective resolution should retain a slight increase in frequency. The larger effect here is a reduction in noise. Combining two prototype perspectives should ideally provide a 3 dB improvement in signal to noise, as should each following doubling of perspectives. Combining interpolated perspectives from 8 different source perspectives should ideally be capable of providing a 9 dB signal to noise improvement.

Perform a merit based merge of interpolated perspective views into output perspective views. Each source perspective provides a candidate interpolated perspective to help create a desired interpolated perspective. In the extreme case, a single perspective could provide all desired output perspectives with some loss of information, quality and resolution. Normally a number of candidates corresponding to the number of source perspectives are combined to produce each output perspective. Each pixel of each source perspective has a figure of merit which indicates its relative contribution to the output perspective. The merge operation retains the highest available figure of merit data for each pixel, applying an average or regression analysis to multiple values at highest merit.

Arbitrary real time pan and zoom available within the volume of interest. The ECT used for primary signal processing is capable of arbitrary pan and zoom operations as desired.

In algorithm step 214, the processor 34 generates formatted output data based on image parameters of the display device 16 and displays the desired output perspective view 66 of the volume of interest on the display device 16 using the formatted output data.

Generate real time output for presentation on 2D video, stereoscopic and 3D displays. In the output stage data is formatted for the desired display(s). 2D display at HD, 4K, or 8K requires a single perspective. Stereoscopic display requires a left and right eye perspective, while current Lightfield monitors typically require an array of 45 perspectives.

Improve on currently available BIOM performance. BIOM lenses interface a wide field of view of typically 60 to 120 degrees, to a relatively narrow cone of 12 to 20 degrees. In the case of the Camtrx LightField3D™ approach, the cone of view can be much wider, which would appear to provide the opportunity for a more efficient BIOM lens.

Calibrated interaction with motion paths and micro-manipulation. The calibrated volume of interest ties a specific 3D volume and scale with all perspective image processing. A natural extension to the feature set would be to support motion path design, simulation, visualization, and control within this volume, which could then be interfaced with external servo device control if desired.

User Interface presentation and control. The ECT based image processing path can support User Interface Display on the generated perspective views, including grids, windows, prompts and other visual interaction.

Image Enhancement processes in the Elastic Convolution Transform. The ECTs being used to implement the perspective extraction are capable of doing more without impacting overall latency. Digital windowing and zoom are possible. Homomorphic and phase contrast filtering are popular in many medical applications for the ability to enhance low level contrast and detail dramatically. Boosting specific portions of the frequency spectrum, and special color combination sensitive operations are also possibilities.

Depth Measurement Artifacts. The depth measuring method described may produce local ambiguities in the depth map if the surface has deep holes, discontinuities, reflections, very steep transitions or similar surface anomalies. These could be reduced by applying a rule set filter. (not too low, not too high, not to steep, etc.) local ambiguities could produce local visual artifacts. An alternate method or a dual depth measurement method may be desired.

Second Order View Interpolation. The method described in detail above is a first order interpolation of a geometric perspective conversion. Protrusions, voids, steep transitions, internally generated shadows and reflections could all generate local artifacts under this form of perspective rotation. To improve on this, a second order interpolation would need to “understand” these special cases, generate a conceptual 3D model with correct shape, color, and specular or diffuse reflection, and then render the desired perspectives using a 3D ray tracing type approach. Although possible, it would be exceedingly difficult to do fast enough to support good hand-eye coordination.

In some embodiments, the one or more processors 34 may performing algorithm 400 for rendering 3D video images of the volume of interest onto the display device 16. For example, in algorithm step 302, the processor 34 may operate Illumination and Control using on axis external illumination which is particularly significant for fundus viewing, which may eliminate the need for invasive internal fiber optic illumination methods in most cases. The processor 34 may also operate hyper-spectral Illumination and Control for improved tissue visibility and identification, adding support for near infrared and possibly near ultraviolet wavelengths, emission and sensor polarization, and narrow spectrum pulsed illumination synchronized to image sensor integration time, to analyze differential absorption, reflection, auto-fluorescence and birefringence.

In algorithm step 304, the processor 34 operates the image acquisition sensor array including on the order of eight image sensors arrayed around a central axis and aimed so that individual optical axis all converge at a single point on the central primary axis at the bottom center of the volume of interest. Image Acquisition Hyper-Spectral Sensor Array (with optional filters and polarizer) may be used to support some hyper-spectral capabilities. A portion or potentially all image sensors can be replaced with high quantum efficiency broad spectrum sensors. These broad spectrum sensors would provide similar angular resolution and use the same lens assemblies. Optional polarizing or narrow wavelength filters may also be used. Camera lens assembly would support various optical wavelength pass and blocking filters and polarizing filters for various differential analytical capabilities to support hyper-spectral analysis of various optically active substances and tissues.

In algorithm step 306, the processor 34 performs source image perspective view auto-calibration. For each perspective view camera and lens assembly, the processor 34 performs: Frame storage and read/write interface portal for computer read/write access to image data used for collecting raw auto-calibration images, system testing, and development; Data storage and read/write interface to auto-calibration control data used to store the precomputed auto-calibration Elastic Convolution Transform (ECT) program which implements the desired calibration of each perspective view; and ECT Transform for image calibration based on auto-calibration data to obtain: Position & Geometric Orientation Correction; Geometric Distortion Correction; Wavelength/color and position specific MTF Correction; and Wavelength/color, position, and depth specific Focus Correction.

The processor 34 may also perform Hyper-Spectral Calibration with specific illumination, calibration target features and filters to fully map performance throughout desired spectrum. Bayesian super-resolution can under some conditions do an excellent job of correcting focus and point spread. If auto-calibration information can be converted into adequate prior constraints then a Bayesian inverse problem process could likely address these operations for both visible and extended spectrum.

In algorithm step 308, the processor 34 performs Auto Calibration Computer Interface.

In algorithm step 310, the processor 34 performs Coarse Depth Analysis. Coarse depth analysis endeavors to generate a depth and occlusion map for the cone of view in each frame time, with roughly 1 mm resolution within the volume of interest. The processor 34 may also perform Occlusion Detection and Perspective View Masking using Coarse depth analysis to detect occlusions unique to a single perspective or above the volume of interest. In either case, a low resolution occlusion mask indicates the occluded portion of particular perspective image(s) to later processing steps. The mask information is used later to either entirely remove the occlusion or provide a largely transparent or translucent analog.

In algorithm step 312, the processor 34 performs High Quality Low Latency Depth Analysis using Iterative Depth Cost. Higher quality depth information is desirable to enable better super-resolution results. High quality depth analysis computes the surface depth and detects occlusions within the volume of interest (VOI). Any improvement over Coarse Depth Analysis can provide some improvement in super-resolution results. Depth resolution on the same order as the linear pixel pitch within the VOI would be ideal.

In algorithm step 314, the processor 34 performs Depth Aware Perspective Merge including: Perspective Rotation, Translation, Projection, Magnification, Filtering by ECT; Perspective merit is derived from relative gradient which is derived from depth map and perspective; and Perspective Scale and Merge operation supporting Merit Based Super-Resolution. The processor 34 may also perform User Viewing Angle Optimized Perspective Merge; Scale and Merge with Oversampled Super-Resolution; Scale and Merge with Bayesian Super-Resolution; Hyper-Spectral feature detection with some basic hyper-spectral capabilities were added to provide possible solutions for specific procedures such as replacing dye in ILM peels, and improving blood transparency in neurological procedures; and Hyper-Spectral information to Pseudo-Visual conversion including NUV, NIR and differential information and any other analytical information folded into the visible representation, or possibly added to user interface mask or annotations.

In algorithm step 316, the processor 34 Image Enhancement Filtering User Options Implemented as an ECT processing stage including Frequency response reshaping, pass band control, noise reduction, etc.; Homomorphic filtering; Phase Contrast filtering; and Vector Operator Derived Filtering.

In algorithm step 318, the processor 34 performs Computer Interface Portal for Image Read/Write, Windowed UI and Diagnostic Access including Computer enabled user interface windowed displays and overlay functions; Initial development and testing support including: Computer Assisted Image Enhancement and advanced filtering; Computer Assisted Bayesian Super Resolution development; and Computer Assisted Feature Search, Measurement and Identification; support computer assisted advanced features in production model; and Generate Diagnostic Information and Metadata.

In algorithm step 320, the processor 34 Merges Output Perspective with User Interface Data & Annotation.

In algorithm step 322, the processor 34 Generates Final Perspective Views for the desired output(s) including: Generate Lightfield Monitor Resolution and Perspectives; Generate Stereoscopic Headset Resolution and Perspectives; and Generate Video Resolution Perspective.

In algorithm step 324, the processor 34 performs Image Output Formatting including: Lightfield Monitor 3D output formatting; Stereoscopic Headset stereoscopic output formatting; and Video output formatting.

In some embodiments, the processor 34 may be programmed to display the desired output perspective views 66 on a wearable augmented/extended reality (AXR) headset 70 adapted to be worn by a user. For example, in some embodiments, the lightfield imaging system 10 may include a wireless transceiver for use in wirelessly transmitting the formatted output data of the desired output perspective views to the AXR headset 70 for viewing by the user. Additional details of the AXR headset 70, which may be used in the present invention, are described in U.S. patent application Ser. No. 17/139,167 to David Kessler et al., filed Dec. 31, 2020, titled “Wearable Pupil-Forming Apparatus”; and U.S. patent application Ser. No. 18/531,248 to David Kessler et al., filed Dec. 6, 2023, titled “Augmented Reality Near-Eye Pupil-Forming Catadioptric Optical Engine in Glasses Format”, which are incorporated herein by reference in their entirety. The AXR headset 70 may be, for example, the ORLenz™ Extended Reality Visualization headset sold by Ocutrx™.

In some embodiments, the processor 34 may be coupled in communication with a controller of an All-Digital Multi-Option 3D Viewing Theatre (ADMO3DV) system 72 including a 3D autostereoscopic monitor (3DAM) 74, a 3D digital viewport (3DDV) device 76, and the AXR headset 70. The processor 34 may be programmed to transmit the formatted output data of the desired output perspective views 66 to the controller of the ADMO3DV system 72 to display the received images on the 3D autostereoscopic monitor 74, the 3D digital viewport device 76, and/or the AXR headset 70. Additional details of the All-Digital Multi-Option 3D Viewing Theatre system 72, which may be used in the present invention, are described in U.S. patent application Ser. No. 18/450,997 to Michael H. Freeman et al., filed Sep. 6, 2023, titled “Surgery Visualization Theatre”, which is incorporated herein by reference in its entirety. The All-Digital Multi-Option 3D Viewing Theatre system 72 may be, for example, the OR-Bot™ sold by Ocutrx™.

In some embodiments, the lightfield imaging system 10 may include the Camtrx LightField3D™ sold by Ocutrx™. The Camtrx LightField3D™ employs novel optical, lightfield, and signal processing techniques to combine high resolution, low latency, 3D perspective, and user configurable advanced analytical and image enhancement tools into an integrated product.

During operation of the lightfield imaging system 10, following power up, the user can specify illumination by a broad or narrow spectrum for each primary, as well as type of display (single perspective, stereoscopic, or lightfield). An auto-calibration process then measures various physical positions and orientations, as well as any optical distortion. Auto-calibration data is used to generate processes to calibrate depth perception measurement and image perspective input and generation of interpolated perspectives output. Measured displacements, geometric distortion and modulated transfer functions are all utilized to provide a calibrated common reference framework. In addition, this information is used to generate the corrective processes driving various Elastic Convolution Transform operators (ECT) to produce calibrated depth sensor data from the raw sensor data and to calibrate image sensor data from the raw perspective sensors, as well as generate the processes that drive the ECT processes which generate the interpolated perspectives.

Common Reference Framework (CRF). The common reference framework is a 3D map of the sensors and projectors and their relation to the volume of view, volume of interest and surface of interest and what corrections are required to map image sensor, depth fiducial and depth sensor data onto that framework. Auto calibration data is used to generate ECT programming to convert these various image sensor data sets onto this common reference framework.

ECT Programming. ECT programming is the control data structure which determines the specific action that ECT hardware will implement. ECT programming typically supplies at least a source address, destination address, and selection of desired process (convolution, LUT, etc) for each data element processed (sample, pixel, color component, etc.). Either source or destination addresses may be implied by some default progression or generator function in the case of a purely geometric transform. ECT processing is typically implemented in a Field Programmable Gate Array (FPGA) or Application Specific Integrated Circuit (ASIC). An ECT is well suited to implement an arbitrary elastic conversion with value specific processing, and can typically include non-linear data value mapping and frequency domain transforms with no added processing time.

Conversion of Auto-Calibration Data into ECT Programming. The auto calibration data and user option settings are used to generate three sets of ECT programming. These include three sets of transforms: #1-ECTs to convert raw depth data from each depth sensor into geometrically calibrated data in the 3D CRF for that sensor, #2-ECTs to convert each set of image sensor data and corrected depth data into 3D image data in the 3D CRF, and #3-ECTs to convert 3D CRE image data into the required planar perspective views needed for the selected output.

Depth Map Data Acquisition and Calibration. An accurate surface depth map in the CRF is critical for the 3D analysis of the image sensor source perspective correction ECT programs as well as the following perspective interpolation ECT programs. A surface depth measurement process collects depth image sensor data, then analyzes it for depth information and then uses an ECT programmed using auto-calibration data to map that depth map data onto the CRF, by removing any geometric or optical distortion. This depth information is critical to the analysis of source image perspectives as well as generation of interpolated output perspectives.

Input Perspective Correction ECT Program Generation. The required input geometric and optical distortion for each image sensor is known from autocalibration. With this data, the ECT transform control code to calibrate input image sensor data and depth data into 3D CRF format can be produced.

Interpolated Output Perspective ECT Program Generation. The output perspectives are generated from the 3D CRF image perspectives and depth map data. The required output perspectives are known when the output option is selected by user configuration. This provides the data to generate the individual ECT programs for each interpolated perspective.

### Actual Operational Processing

Depth Map Extraction. Depth processing consists of depth image sensor sampling, followed by depth analysis and finally calibration to the 3D CRF reference space. Depth analysis is done by local frequency component analysis. The raw depth grid is then mapped to the 3D CRF using auto calibration data. Depth analysis consists of dividing the depth image into overlapping tiles, windowing the tile to highlight central data, transforming the tile using a sample to frequency domain transform, masking to access the desired frequency components, and then using either a depth of focus, focal point spread or geometric projection line spread analysis to map the frequency data into depth data. Depth data can be significantly lower resolution than image pixel resolution. For example, if a roughly 1 mm depth resolution is adequate, a 50 mm diameter region of interest would easily be covered by a 100×100 depth data point grid. If a 2000×2000 pixel depth image sensor is used, 40×40 pixel overlapping tiles would be satisfactory for depth extraction.

Depth Map Calibration. Depth map calibration into 3D CRF is done by the ECT and control program created for that purpose using auto-calibration data. This compensates for any positioning, orientation, geometric or optical distortion detected during auto calibration.

Image Acquisition, Correction, Perspective Generation and Interpolation. Image data is collected from a number of image sensors covering a number of perspectives. Each image perspective has its own ECT program which converts that image data combined with the 3D CRF version of the current depth map, into 3D CRF space. Some image filtering and image enhancement operations can be folded into this transform to provide these capabilities with no increase in latency.

Perspective Interpolation. The surface depth map and corrected image perspectives are used to interpolate the required output perspectives using the 3D CRF image and depth data and the ECT transforms and controlling data sets generation from output selection. Each input perspective can be converted into a prototype of each desired output perspective. The desired output perspectives are then merged into the final perspectives by evaluating a per pixel merit function which indicates the quality of each contribution from each perspective. Some image filtering and image enhancement operations can be folded into this transform to provide these capabilities with no increase in latency.

Image Enhancement. Image enhancement can provide a wide number of user configurable services to improve clarity and utility. In many cases enhancement can be folded into other processes. In other cases typically involving full image forward and reverse transforms, additional latency may be required. Image enhancement includes ultra high quality real time image resizing to support desired resolutions and formats.

Image Output Formatting and Display. The image stream can be formatted for display on conventional, stereoscopic, or lightfield displays. Processing options can be provided to provide some or all of these formats concurrently. Output can be formatted into media formats for video recording or media compression.

Operational Timing Overview. Processing times estimated on 10 ms image acquisition integration time and mid-range FPGA part based processing time times Assumes 10 ms frame image acquisition time, and 5 ms processing time increments; t+N is N×5 ms before or after source images are acquired; t−2 is the beginning of the current view beginning of sensor integration; t−0 is the current view accessible at the sensor; t+4 is the current view ready for output to display device.

Depth Map Acquisition and Analysis. Acquire Depth Image t−3 & t−2; Analyze Depth Information t−1; Corrected Dept Image available t−0.

Image Acquisition, Correction, Perspective Generation and Interpolation. Acquire Perspective Images t−1 & t−0; Correct Perspective Images t+1.

Perspective interpolation transform generation. Needs processed depth data; Generate interpolation transforms t+1.

Perspective Interpolation. Generate Interpolated Perspectives t+2

Image Enhancement. Most cases of: Modification of frequency domain; Homomorphic filtering; Noise coring; Color space conversions; Pseudocolor processing; Folded operations no change in latency; Filters requiring forward and reverse full image transforms: Phase contrast filtering; Assured channel quality filtering/conversion; Perception filtering; High quality resizing; Forward and reverse transform 10 ms.

Image Output and Display. Formatted output t+3; Begin transfer to Display t+4; Nominal Processing Latency 20 ms; Frame to Display transfer 5 ms; Acquisition, processing, display 10 ms+25 ms+ (1000 ms/display frame rate).

Power up and Optional Selection of Spectral Illumination. On power up, the system performs self tests of all critical systems. After initial self test, the user can select from available spectral options, if their system includes this option. Narrow spectral primaries can be implemented either by using mono chromatic light sources for illumination, or narrow band filters applied to broadband sources, or notch filters with image sensors. Using narrow spectrum primary color component illumination has several potential benefits. A definite advantage is that the computational geometric correction and computational focus correction can do a much better job if lens geometric distortion and focus point spread are better controlled. This results in much sharper images and greater useful depth of focus. As an example, instead of relying on broad spectrum white light, LED illumination of RGB primaries of 650 nm, 550 nm, and 450 nm+/−5 nm would provide these advantages.

An additional area of potential benefit is the ability to utilize particular spectral components to provide increased tissue transparency or more selectivity of particular tissues. Any desired spectral component color primaries, pseudo-color space or other custom illumination should be selected before auto calibration, so the particular sources to be used are measured and calibration is optimized for their use. Imagery on display is converted to conventual human viewing color space for display.

Depth Perception Mechanisms. The Camtrx LightField3D™ microscope acquires multiple perspective views of the surface of interest within the volume of interest. The multiple perspectives provide information to interpolate perspective views for a three-dimensional display output, as well as minimizing visual interference by objects above the volume of interest such as tools or hands which would otherwise occlude the view. To accomplish this ability to look “through” or “around” occlusions, as well as providing a realistic 3D view of the surface of interest, multiple perspectives are captured by multiple image sensors with various perspective views. The wider the range of captured perspectives, the greater the ability to implement this “look around” or transparency feature. To construct the desired output perspectives from the available source perspectives with low processing latency suitable for good hand-eye coordination, a fast geometric construction method of perspective interpolation is desired. There are two general approaches possible. One approach to perspective interpolation is to use auto correlation or feature recognition in the various perspectives to detect reference objects and their orientation in the various perspectives, then use this information to generate a 3D volumetric model of the volume of interest, and then render the desire output perspectives using that 3D model. Unfortunately, a number of these steps require long computations resulting in unacceptable latency. An approach which can achieve the desired low processing latency is geometric perspective interpolation. If the relative positions, fields of view, and geometric and optical distortions, and the profile of the surface of interest are all known well enough, then desired output perspectives at high resolutions can be calculated rapidly. Geometric perspective interpolation requires a depth map of the surface of interest. Possibilities for depth map generation include near range LIDAR or high frequency SONAR as well as the proposed near InfraRed optical pattern projection, image capture and analysis. Each of these approaches are capable of producing a depth map with roughly 1 mm depth and positional resolution. The Camtrx LightField3D™ microscope could potentially use any of these mechanisms individually or in combination to create the desired surface depth map.

Several approaches can be used for near infrared optical depth measurement. The point spread function can easily be measured in the image resulting from projecting a pattern onto the field of interest and capturing the resulting picture. If optimum focus occurs at the maximum depth of the field of interest and is significantly out of focus at the minimum depth of interest, then the point spread function can be used to determine depth. A similar alternative relies geometric line spread by projecting a 2D grid and measuring the geometric divergence of that grid on the surface of interest. In both cases, local Fourier transforms can be used to directly measure the optical projections and provide the required depth map. These two optical methods are similar enough that they can in some cases be combined to provide a cross reference. In order to operate in spite of occluding objects, multiple fiducial depth projectors and sensors are desire.

Depth Map Processing delay relative to image processing latency. If image acquisition, image processing, and resulting perspective display are inserted into the hand-eye coordination loop, the quality, accuracy, and responsiveness of that coordination diminishes rapidly if image latency exceeds a few tens of milliseconds. Image Latency is the time from image acquisition until display. With training, a user can adapt to compensate to some extent, but it is very desirable to keep latency as small as possible. Toward this goal, the depth processing time is independent of the image processing path. This is reasonable because the depth map typically changes more slowly than the image, and when the depth map does change dynamically, the motion can typically be projected into the future by analyzing recent history for motion and providing a good estimate of future surface position. As a result, depth map processing latency is decoupled from image processing latency.

Perspective Acquisition. Images at various perspectives of the field of interest are acquired with multiple image sensors. These sensors either share a single optical path with multiple perspective optics, or individual cameras and lenses with their axis passing through the center of the cone of view. In the case of the shared optic, optical magnification is also provided in steps of 2×. This is in addition to magnification provided in the image signal processing path. In the case of camera arrays, they can be in a linear array or arc across the base of the cone of view. In the case of the arc configuration, it can be extended to extremes allowing excellent occlusion look-around. Four to six perspectives are typically distributed across the base of the cone of view, with two rows of three to five perspectives above and below the previous sensors, to provide a symmetrical frequency response in the interpolated perspectives.

Auto Calibration. Calibration assures best case performance by measuring positioning of critical components, and optical performance parameters and applying them to the correction process. This approach assures that positioning and orientation of sensors can be assured to on the order of one micron, while similar resolutions can be supported by the optical performance. This approach also simplifies assembly, shipment, maintenance, and assures proper operation by compensating for mechanical alignment, thermal expansion, and assures the use of actual illumination, as well as optical lens and sensor performance. During auto calibration, a test fixture is either attached or enabled and extended to sweep through the volume of interest. The test fixture provides a test pattern, and an actuator which can be accurately positioned to sweep the test pattern through the volume of interest. The Auto Calibration test pattern fills a plane of the field of interest and can precisely sweep the entire volume. The test pattern provides a reference geometric pattern which facilitates measurement of sensor and optics axis alignment, alignment angle, and scale, as well as the per color component MTF response and per color component optical geometric distortion at all locations in the volume of interest, and the illumination intensity profile for each color primary. This calibration includes both image sensors and depth sensor performance, and depth illumination primary.

Auto Calibration of Depth Map Pattern Projection. It is desirable that the Depth map data is very resistant to occluding objects above the volume of interest. This argues for multiple depth reference projection sources. For this reason, three projectors are anticipated, located in a ring with a projector sources every 120 degrees. If these are projecting x-y grids, rotating each by 30 degrees from the others provides grid lines at 0, 30, 60, 90, 120, and 150 degrees. This allows lines to be analyzed together or in part using local Fourier transforms both to select and to measure. All three sets of grids provide redundant depth measurement which should provide reasonable resistant to occlusion. Depending on the method of projection, either line separation or line spread can be used to analyze depth. Spectral filters often have some cross talk with other wavelengths. A near IR filter which passes the depth map will also pass some amount of visible wavelengths. The maximum possible spectral crosstalk magnitude should be much less than full scale sensor output and can be removed by retaining only signals exceeding a threshold.

### Depth Map Pattern Projection Methods: Point Spread; Line Spread

Auto Calibration Position, Orientation and Geometric distortion correction. It is assumed that each depth projection image will be slightly different, with differing geometric projection and slightly different optical behavior and alignment. The same issue is assumed for each depth projection sensor. Auto calibration collects the data which enables compensation for these issues in the depth projection analysis. Using the known depth and position information provided by the calibration target as it is swept through the volume of interest allows any geometric or optical distortion or alignment to be detected and a correction map to be generated so that all sensors agree using any or all projection sources and sensors in any combination.

Auto Calibration Depth correction data set generation. Sensor data (images) of the test pattern as viewed by the depth sensors is collected during autocalibration. Correcting for any geometric orientation of projectors and sensors and obtaining good agreement from each channel is critical to reliable determination of surface depth. In a relatively non time critical process, geometric and optical distortions are determined throughout each sample plane in the volume of interest. A transformation map describes the transformation required to map the source observation from each individual sensor to the desired result for each point of interest in each plane throughout the volume of interest. The size of this data set is manageable due to the fact that these parameters are highly correlated in the volume of interest and can be adequately represented at sample resolutions much lower than the image resolution. For example, a correction map of 100×100×50 entries which can be interpolated to full desired resolution would typically be suitable even for very high image resolution.

Operation. Operation consists of three primary concurrent processes which are surface depth map computation, image perspective acquisition, and image perspective interpolation and display. To keep latency as low as possible, surface depth map computation is done concurrently with the image processing but outside the latency path from sensor to display. Allowing image processing to use a slightly old surface map reduces latency by about a factor of two, and is typically tolerable because the surface map is typically less dynamic than changes of perspective or motion above the surface of interest.

Operational Depth. Required depth resolution is much less than required image resolution. The assumption is made and verified during auto-calibration that fiducial pattern projection and depth sensor axis alignment and placement are “close”, with close on the order of one millimeter. The geometric and optical error related to depth perception are mapped for the volume of interest during auto-calibration, with the assumption that geometrically imposed error will be minimal, and geometric corrections can be made after depth analysis, using an x, y, z index into the 3D correction data for each sensor. Sensors then “vote” for the actual depth. Depths above the top or below the bottom of the volume of interest are considered occlusions or voids. Depths within the volume of interest are valid. If a location has no valid votes, it is considered a void. Voids can be “filled” with the nearest valid depth, or set to the maximum depth.

Operational Depth Calculation. Depth images are cored to remove possible cross talk from visible primaries. Then depth images are divided into overlapping squares. For instance, if a depth sensor image is 2000×2000 pixels, and fiducial grid separation at maximum depth is on the order of 20 pixels, it could be divided into 100×100 or 10,000 squares of 40×40 pixels. The squares of depth data are Fourier transformed, and masked by the orientations of potential depth information. The largest remaining components are converted to frequencies, noise reduced by discarding the highest and lowest and averaging the remainder, which is then mapped to depth. A frequency based analysis can also be applied if the fiducial grid is a lens focused optical projection which is at sharp focus at maximum depth of interest, and is out of focus with increased point spread at minimum depth of interest.

Operational Depth Correction. If geometric distortion of the depth fiducial pattern is known to be significant enough to justify correction, a correction of the depth map shape can be done based on the auto-calibration information and using an elastic convolution transform to stretch the x, y geometry as required. The depth (z) information is considered to be correct based on the assumptions above, and only the x and y displacements need to be corrected.

Operational Depth Map and Depth Map Prediction. The depth map representing the surface profile is calculated for every input frame time with roughly 10 to 20 milliseconds of real time delay. If the surface profile is very dynamic, motion estimation can be applied to the current and historic depth maps, to predict future depth maps as required.

Image Acquisition and Correction. The Camtrx LightField3D™ microscope acquires multiple perspectives simultaneously with the ability to interpolate intermediate perspectives from the acquired perspectives. In order to accomplish this with minimal latency a geometric construction method is employed. Geometric construction requires the source image perspectives to be in a normalized form with accurate relative positioning and scaling of the image perspectives, correction of lens distortion, and the depth profile of the surface of interest. Normalization of sensor acquired image perspectives relies on information obtained during auto calibration. The calibration data is used to produce a specialized data structure for each image sensor which controls the ECT transform of each input frame from each image sensor into an idealized representation with a precisely known geometric relationship to all other captured perspectives. Interpolation of new perspectives requires generation of perspective interpolation control data. Perspective interpolation requires ECT processing and control for each source perspective and a merge operation to combine all source perspectives and resolve regional resolution priorities. Regional priorities are determined by how well a given source perspective can represent a region n the output perspective, which is dependent on the viewing angle and the surface angle. The preferred perspective for that region has the viewing angle closest to perpendicular to the surface in that region. The same perspective interpolation process can also add text, grids, windows and other user information if desired.

Optical distortion correction applied to each color component. A complex lens system can easily exhibit worst case geometric distortion exceeding many pixels at the image sensor. Making the problem even more severe, this distortion can be dramatically different for each color component. This can be devastating to high frequency resolution and image quality if not corrected. Fortunately, an ECT is an ideal process to correct for this distortion as well as providing a high quality convolution based color decode.

Filtering and image enhancement. A sequence of generic processing blocks can implement a wide range of useful operations. A nonlinear value remap, followed by a forward transform, nonlinear remap, multiplication by a frequency response map, nonlinear remap, and an inverse transform followed by a final nonlinear value map can provide a wide range of noise reduction, frequency domain modification, homomorphic, phase contrast, and other filtering operations which can increase quality and highlight selected features dramatically.

High Quality Image Resizing using ECT transforms. The Elastic Convolution Transform (ECT) used to correct geometric distortion and interpolate new perspectives can also be used to provide the desired output image resize, allowing source images to be scaled or stretched either up or down. In this case the ECT effectively implements a Lanczos windowed interpolation convolution which is considered to provide excellent image quality. In many cases where an ECT is being used for other image processing steps, a resize operation can be combined with no additional processing steps.

High Quality Transform Based Resizing using Image Enhancement Mechanism. The ultimate in resizing is full image transform based resizing, which can remove the majority of sampling noise and increase signal resolution while providing an ultra high quality resize.

Display on a Stereoscopic Headset. A stereoscopic headset provides a relatively high resolution left and right eye perspective view without constraining to viewer to a particular position. This has the potential to greatly improve the ergonomics of long and/or delicate procedures. Use of a stereoscopic headset with the Camtrx LightField3D™ microscope requires generation and output of left and right image streams of interpolated perspectives. The viewing perspective can be controlled by head position, orientation, or manual user interface control. Generating left and right eye perspectives require interpolating each view from available perspectives.

Display on a Lightfield Monitor. Current lightfield monitors display a “3D” image by optically filtering selected views based upon viewing angle. Current practice is to display an interleaved array of 45 different perspectives which present the appropriate perspectives by directional optical filtering and the actual eye positions and angles of view. Processing required to generate interpolated perspective views is largely proportional to the number of pixels required. Producing 45 perspectives at 1/45 resolution is only slightly more processing work than producing one perspective at full resolution. The primary increase in computational throughput over a stereoscopic view results from all source perspectives being active concurrently, and the additional formatting required for the output stream.

Recording output. Both stereoscopic and lightfield output can be recorded on appropriate video equipment or as media files when operating at a supported frame rate.

In some embodiments, the lightfield imaging system 10 may include: 1. Hardware and software comprising a non-transient computer model-view-controller (MVC) and video sensor processing control; 2. A microscope housing comprising: a. A power supply; b. A weighted base; c. An articulating or robotic arm; d. A computer controller with monitor; e. Wired and/or wireless video connections comprising: i. Transferring wired information to a 3D monitor or ii. Transferring wireless information to an Augmented Reality/Extended Reality or Virtual Reality-Mixed Reality headsets; f. An aiming function with an x,y-axis (mechanical and digital) module electronic controller; g. A focusing function with a z-axis (focus) (optical, mechanical, and/or digital) module electronic controller; h. A lighting mechanism for illuminating the subject (surgery) area; i. An optical and/or digital zoom-magnification mechanism; j. An external footpedal or other mechanism to control the above; 3. One or more microscope lens housings containing optical lenses culminating in a objective lens over the subject (surgery) site; 4. A microscope lens sequence consisting of: a. a collimating objective lens that gathers light from the object being observed; b. a relay lens that forms an intermediate image of the object; c. an aperture stop following the relay lens; d. a relay lens that collimates the intermediate image and forms an image of the aperture stop; 5. a video sensor array capturing images from the microscope lens sequence consisting of lens/sensor pairs comprising: a. at least more than two video sensors; b. aspheric focusing lenses attached to each video sensor; c. the lens/sensor pairs configured in an array where the lens/sensor pairs are located at the image of the aperture stop of the microscope lens sequence which focuses the photons which create the recorded image from different perspectives in real-time; d. an MVC data transfer protocol to separately transfer synchronized lens/sensor pair data; 6. A computer vision processing interface which includes a method of 3D reconstruction from the various lens/sensor pairs. 7. A computer vision processing interface to interpolate the necessary views needed to show a holographic image generated from the lens/sensor pairs imaging. 8. One or more holographic display which presents an effectively continuous views of the subject site interpolated from the lens/sensor pairs. 9. A method whereby an overlay of information is integrated into the real-time video feed such as highlighting specific areas of the 3D video based on parameters such as depth (such as in a surface mapping) or color (such as identifying a specific color).

In some embodiments, the lightfield imaging system 10 may perform a method of creating a 3D color mesh using a sampling of the plenoptic function derived from the different perspectives recorded by the sensors and a method of generating an array of images of the 3D color mesh for use in constructing a holographic video image.

The lightfield imaging system 10 may also include a holographic display which presents a live magnified 3D image of the object being observed.

Lightfield imaging has several advantages as compared to traditional two-dimensional imaging. Among these are holographic display, depth, and feature recognition, digital refocusing and autofocus, occlusion insensitivity, increased depth of field.

With the present invention, diagnostic data such as preoperative OCT can be overlayed on the three-dimensional image for subsurface feature display.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification. It will be apparent to one having ordinary skill in the art that the specific detail need not be employed to practice according to the present disclosure. In other instances, well-known materials or methods have not been described in detail in order to avoid obscuring the present disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the present invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Although specific features of various embodiments of the invention may be shown in some drawings and not in others, this is for convenience only. In accordance with the principles of the invention, any feature of a drawing may be referenced and/or claimed in combination with any feature of any other drawing.

The invention has been described in detail with particular reference to a presently preferred embodiment, but it will be understood that variations and modifications can be effected within the spirit and scope of the disclosure. The presently disclosed embodiments are therefore considered in all respects to be illustrative and not restrictive. The scope of the invention is indicated by any appended claims, and all changes that come within the meaning and range of equivalents thereof are intended to be embraced therein.

What is claimed is:

1. A lightfield imaging system, comprising:
a display device for displaying three-dimensional (3D) video images of a volume of interest; and
a lightfield microscope assembly, including:
a microscope housing;
a multiple angle capture (MAC) sensor array including a plurality of sensors mounted to the microscope housing;
an objective lens assembly mounted to the microscope housing and configured to direct light rays from a volume of interest to each sensor in the MAC sensor array; and
a microscope controller coupled to the display device and the MAC sensor array, the microscope controller including a memory device storing computer-executable instructions and one or more processors executing the computer-executable instructions to perform operations for rendering 3D video images of the volume of interest onto the display device including the steps of:
operating the MAC sensor array to capture video frame perspective image data of the volume of interest, wherein each sensor in the MAC sensor array captures a different overlapping image perspective of the volume of interest;
generating calibration data for each MAC sensor in the MAC sensor array indicating optical performance and physical sensor orientation;
generating corrected perspective view image data for each MAC sensor in the MAC sensor array based on the captured video frame perspective image data and the calibration data;
generating a surface depth map of the volume of interest based on the corrected perspective image data;
generating calibrated volume of interest (CVI) image data for each sensor in the MAC sensor array by mapping corrected perspective view image data onto the generated surface depth map;
generating single source interpolated perspectives views for each sensor in the MAC sensor array based on corresponding CVI image data;
merging the single source interpolated perspective views into a desired output perspective view of the volume of interest;
generating formatted output data based on image parameters of the display device; and
displaying the desired output perspective view of the volume of interest on the display device using the formatted output data.

2. The lightfield imaging system of claim 1, wherein the one or more processors perform the algorithm including the steps of:
generating calibration data for each sensor in the MAC sensor array indicating optical performance and physical sensor orientation of each sensor in the MAC sensor array;
generating corrected perspective view image data for each sensor in the MAC sensor array based on the captured video frame perspective view image data received from each sensor in the MAC sensor array and the calibration data; and
generating the surface depth map of the volume of interest based on the corrected perspective view image data.

3. The lightfield imaging system of claim 2, wherein the one or more processors perform the algorithm including the steps of:
generating the calibrated volume of interest (CVI) image data for each sensor in the MAC sensor array by mapping the corrected perspective view image data onto the generated surface depth map.

4. The lightfield imaging system of claim 1, wherein the one or more processors perform the algorithm including the steps of:
assigning a figure of merit value for each pixel of each sensor in the MAC sensor array indicating a significance of a corresponding pixel to the desired output perspective view; and
generating each single source interpolated perspectives view including a figure of merit value for each pixel.

5. The lightfield imaging system of claim 4, wherein the one or more processors perform the algorithm including the steps of:
merging the single source interpolated perspectives views into the desired output perspective view based on each figure of merit value of each pixel.

6. The lightfield imaging system of claim 4, wherein the one or more processors perform the algorithm including the steps of:
determining a relative location of each pixel with respect to the volume of interest based on the surface depth map; and
assigning the figure of merit value for each pixel based on the determined relative location of each pixel.

7. The lightfield imaging system of claim 1, wherein the one or more processors perform the algorithm including the steps of:
generating the single source interpolated perspectives views for each sensor in the MAC sensor array using Elastic Convolution Transforms.

8. A method of operating a lightfield imaging system including a display device for displaying 3-dimensional (3D) video images of a volume of interest and a lightfield microscope assembly including a microscope housing, a MAC sensor array including a plurality of sensors mounted to the microscope housing, an objective lens assembly mounted to the microscope housing and configured to direct light rays from a volume of interest to each of the sensors, and a microscope controller coupled to the display device and the sensors and including a memory device for storing computer-executable instructions thereon and one or more processors, the method including the one or more processors executing the computer-executable instructions and performing an algorithm for rendering 3D video images of the volume of interest onto the display device including the steps of:
operating a MAC sensor array to capture video frame perspective image data of the volume of interest, wherein each sensor in the MAC sensor array captures a different overlapping image perspective of the volume of interest;
generating calibration data for each MAC sensor in the MAC sensor array indicating optical performance and physical sensor orientation;
generating corrected perspective view image data for each MAC sensor in the MAC sensor array based on the captured video frame perspective image data and the calibration data;
generating a surface depth map of the volume of interest based on the corrected perspective image data;
generating calibrated volume of interest (CVI) image data for each sensor in the MAC sensor array by mapping corrected perspective view image data onto the generated surface depth map;
generating single source interpolated perspectives views for each sensor in the MAC sensor array based on corresponding CVI image data;
merging the single source interpolated perspective views into a desired output perspective view of the volume of interest;
generating formatted output data based on image parameters of the display device; and
displaying the desired output perspective view of the volume of interest on the display device using the formatted output data.

9. The method of claim 8, including the one or more processors performing the algorithm including the steps of:
generating calibration data for each sensor in the MAC sensor array indicating optical performance and physical sensor orientation of each sensor in the MAC sensor array;
generating corrected perspective view image data for each sensor in the MAC sensor array based on the captured video frame perspective view image data received from each sensor in the MAC sensor array and the calibration data; and
generating the surface depth map of the volume of interest based on the corrected perspective view image data.

10. The method of claim 9, including the one or more processors performing the algorithm including the steps of:
generating the calibrated volume of interest (CVI) image data for each sensor in the MAC sensor array by mapping the corrected perspective view image data onto the generated surface depth map.

11. The method of claim 8, including the one or more processors performing the algorithm including the steps of:
assigning a figure of merit value for each pixel of each sensor in the MAC sensor array indicating a significance of a corresponding pixel to the desired output perspective view; and
generating each single source interpolated perspectives view including a figure of merit value for each pixel.

12. The method of claim 11, including the one or more processors performing the algorithm including the steps of:
merging the single source interpolated perspectives views into the desired output perspective view based on each figure of merit value of each pixel.

13. The method of claim 11, including the one or more processors performing the algorithm including the steps of:
determining a relative location of each pixel with respect to the volume of interest based on the surface depth map; and
assigning the figure of merit value for each pixel based on the determined relative location of each pixel.

14. The method of claim 8, including the one or more processors performing the algorithm including the steps of:
generating the single source interpolated perspectives views for each sensor in the MAC sensor array using Elastic Convolution Transforms.

15. A non-transitory computer-readable storage media having computer-executable instructions embodied thereon to operate a lightfield imaging system including a display device for displaying 3-dimensional (3D) video images of a volume of interest and a lightfield microscope assembly including a microscope housing, a MAC sensor array including a plurality of sensors mounted to the microscope housing, an objective lens assembly mounted to the microscope housing and configured to direct light rays from a volume of interest to each of the sensors, and a microscope controller including one or more processors coupled to the display device and the sensors, when executed by the one or more processors the computer-executable instructions cause the one or more processors to perform an algorithm for rendering 3D video images of the volume of interest onto the display device including the steps of:
operating a MAC sensor array to capture video frame perspective image data of the volume of interest, wherein each sensor in the MAC sensor array captures a different overlapping image perspective of the volume of interest;
generating calibration data for each MAC sensor in the MAC sensor array indicating optical performance and physical sensor orientation;
generating corrected perspective view image data for each MAC sensor in the MAC sensor array based on the captured video frame perspective image data and the calibration data;
generating a surface depth map of the volume of interest based on the corrected perspective image data;
generating calibrated volume of interest (CVI) image data for each sensor in the MAC sensor array by mapping corrected perspective view image data onto the generated surface depth map;
generating single source interpolated perspectives views for each sensor in the MAC sensor array based on corresponding CVI image data;
merging the single source interpolated perspective views into a desired output perspective view of the volume of interest;
generating formatted output data based on image parameters of the display device; and
displaying the desired output perspective view of the volume of interest on the display device using the formatted output data.

16. The non-transitory computer-readable storage media of claim 15, wherein the computer-executable instructions cause the one or more processors to perform the algorithm including the steps of:
generating calibration data for each sensor in the MAC sensor array indicating optical performance and physical sensor orientation of each sensor in the MAC sensor array;
generating corrected perspective view image data for each sensor in the MAC sensor array based on the captured video frame perspective view image data received from each sensor in the MAC sensor array and the calibration data; and
generating the surface depth map of the volume of interest based on the corrected perspective view image data.

17. The non-transitory computer-readable storage media of claim 16, wherein the computer-executable instructions cause the one or more processors to perform the algorithm including the steps of:
generating the calibrated volume of interest (CVI) image data for each sensor in the MAC sensor array by mapping the corrected perspective view image data onto the generated surface depth map.

18. The non-transitory computer-readable storage media of claim 15, wherein the computer-executable instructions cause the one or more processors to perform the algorithm including the steps of:
assigning a figure of merit value for each pixel of each sensor in the MAC sensor array indicating a significance of a corresponding pixel to the desired output perspective view; and
generating each single source interpolated perspectives view including a figure of merit value for each pixel.

19. The non-transitory computer-readable storage media of claim 18, wherein the computer-executable instructions cause the one or more processors to perform the algorithm including the steps of:
merging the single source interpolated perspectives views into the desired output perspective view based on each figure of merit value of each pixel.

20. The non-transitory computer-readable storage media of claim 18, wherein the computer-executable instructions cause the one or more processors to perform the algorithm including the steps of:
determining a relative location of each pixel with respect to the volume of interest based on the surface depth map; and
assigning the figure of merit value for each pixel based on the determined relative location of each pixel.
